(19) United States
(12) Patent Application Publication
(10) Pub. No.: US 2011/0195161 A1
(43) Pub. Date: Aug. 11, 2011

(54) SOLUBILITY ENHANCED TERPENE GLYCOSIDE(S)

(75) Inventors: Mani UPRETI, Dunwoody, GA (US); Indra PRAKASH, Alpharetta, GA (US); Youlung CHEN, Marietta, GA (US)

(73) Assignee: Coca Cola Company

(21) Appl. No.: 13/022,727

(22) Filed: Feb. 8, 2011

Related U.S. Application Data
(60) Provisional application No. 61/302,206, filed on Feb. 8, 2010.

(51) Int. Cl. C08B 37/16; A23G 3/42; A23L 2/00

(52) U.S. Cl. 426/103; 536/103; 426/442; 426/658

(57) ABSTRACT

Disclosed herein are inclusion complexes comprising a substantially pure terpene glycoside and at least one cyclodextrin, wherein the solubility of the inclusion complex is greater than the solubility of the substantially pure terpene glycoside alone. Also disclosed herein are beverage compositions comprising at least one inclusion complex. Further disclosed herein are methods of increasing the solubility of a substantially pure terpene glycoside, comprising combining a substantially pure terpene glycoside with at least one cyclodextrin to form at least one inclusion complex. Still further disclosed herein are methods for improving the taste of an orally ingestible composition and an inclusion complex comprising at least two substantially pure terpene glycoside and at least one cyclodextrin.

This application claims the benefit of priority to U.S. Provisional Application No. 61/302,206 filed on Feb. 8, 2010, which is incorporated in its entirety herein.

The present disclosure relates to inclusion complexes comprising a substantially pure terpene glycoside and at least one cyclodextrin, wherein the solubility of the inclusion complex is greater than the solubility of the substantially pure terpene glycoside alone. The disclosure also relates to methods of increasing the solubility of a substantially pure terpene glycoside, comprising combining a substantially pure terpene glycoside with at least one cyclodextrin to form at least one inclusion complex. The disclosure also relates to compositions comprising at least one inclusion complex comprising a substantially pure terpene glycoside and at least one cyclodextrin, and methods of their production.

Terpene glycosides may include, for example, steviol glycosides and mogrosides. Steviol glycosides are isolated and extracted from the Stevia rebaudiana (Bertoni) plant (“stevia”) commercially cultivated in Japan, Singapore, Taiwan, Malaysia, South Korea, China, Israel, India, Brazil, Australia, and Paraguay. Mogrosides are isolated and extracted from the Siraitia grosvenorii Swingle (Luo Han Guo) vine, cultivated mainly in China. Terpene glycosides are non-caloric sweeteners with functional and sensory properties superior to those of many high-potency sweeteners. For example, processed forms of stevia can be 70 to 400 times more potent than sugar. The use of substantially pure terpene glycosides, however, is often limited or made difficult by their low aqueous solubility or lack of aqueous solubility. Moreover, terpene glycosides may have a bitter component, an astringent and/or metallic taste, and/or a persistent aftertaste or lingering taste. In addition, terpene glycosides may have a slow taste onset.

Accordingly, it may be desirable to identify a manner or way in which to enhance or increase the solubility of substantially pure terpene glycosides. By doing so, the sweetness of a composition may be increased. It may also be desirable to identify a manner or a way in which to improve the taste and/or aftertaste of substantially pure terpene glycosides.

Thus, one aspect of the present disclosure is to address at least one of the above-identified needs by providing inclusion complexes comprising a substantially pure terpene glycoside and at least one cyclodextrin, wherein the solubility of the inclusion complex is greater than the solubility of the substantially pure terpene glycoside alone. A further aspect of the present disclosure is an inclusion complex comprising at least two substantially pure terpene glycosides and at least one cyclodextrin, wherein the solubility of the inclusion complex is greater than the solubility of the substantially pure terpene glycosides alone.

For example, the substantially pure terpene glycoside may be chosen from rebaudioside A; rebaudioside B; rebaudioside C; rebaudioside D; rebaudioside E; rebaudioside F; stevioside; steviolbioside; dulcoside A; rubusoside; steviol; steviol 13 O-β-D-glycoside; suavioside A; suavioside B; suavioside G; suavioside H; suavioside I; suavioside J; isosteviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-1 6-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; 1-[13-hydroxykaur-16-en-18-oate]β-D-glucopyranuronic acid; 13-[(2-O-β-D-glucopyranosyl-β-D-glucopyranosyl)oxy]-17-hydroxy-kaur-15-en-18-oic acid β-D-glucopyranosyl ester; 13-[(2-O-α-L-rhamnopyranosyl-3-O-β-D-glucopyranosyl-β-D-glucopyranosyl)oxy]kaur-16-en-18-oic acid-(2-O-β-D-glucopyranosyl-β-D-glucopyranosyl)ester; 13-[(2-O-β-D-glucopyranosyl-β-D-glucopyranosyl)oxy]-17-oxo-kaur-15-en-18-oic acid β-D-glucopyranosyl ester; 13-[(2-O-β-D-glucopyranosyl-β-D-glucopyranosyl)oxy]-17-oxo-kaur-15-en-18-oic acid β-D-glucopyranosyl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2-O-β-D-glucopyranosyl-β-D-glucopyranosyl)oxy]kaur-16-en-18-oic acid-(6-O-β-D-xylopyranosyl-β-D-glucopyranosyl)ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-β-D-glucopyranosyl)ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl)ester; 13-[(2-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid βp-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-β-D-glucopyranosyl)oxy]kaur-16-en-18-oic acid β-D-glucopyranosyl ester mogroside E; mogroside I A; mogroside I E; mogroside II A; mogroside II A₁; mogroside II B; mogroside II E; mogroside III; mogroside III A₂; mogroside IV; mogroside IV A; mogroside V; mogroside VI; 11-oxomogroside; 11-oxomogroside I A; 11-oxomogroside I A₁; 20-hydroxy-11-oxomogroside I A₁; 11-oxomogroside II A₁; 7-oxomogroside II E; 11-oxomogroside II E; 11-deoxymogroside III; 11-oxomogroside IV A; 7-oxomogroside V; 11-oxo-mogroside V; mogrol; 11-oxo-mogrol; siamenoside; siamenoside-1; isomogroside; isomogroside V; and polymorphic and amorphous forms thereof.

Further for example, the at least one cyclodextrin may be, but is not limited, to ∝-cyclodextrin, β-cyclodextrin, γ-cyclodextrin, or a derivative thereof.

Another aspect of the disclosure is a composition, such as an orally ingestible composition or a beverage composition, comprising at least one inclusion complex comprising a substantially pure terpene glycoside and at least one cyclodextrin, wherein the solubility of the at least one inclusion complex is greater than 0.1% at room temperature. For example, the solubility of the at least one inclusion complex may range from 0.1% to 7%.

Another aspect of the disclosure is a method for increasing the solubility of a substantially pure terpene glycoside, comprising combining a substantially pure terpene glycoside with at least one cyclodextrin to form at least one inclusion complex. The solubility of the at least one inclusion complex is greater than the solubility of the substantially pure terpene glycoside alone.

Other aspects of the disclosure include improving the taste properties of an orally ingestible composition or beverage composition by adding to the composition a substantially pure terpene glycoside-cyclodextrin inclusion complex of the disclosure.

Additional aspects and advantages of the disclosure will be set forth in part in the description which follows, and in part will be obvious from the description, or may be learned by practice of the disclosure. The aspects and advantages of the disclosure will be realized and attained by means of the elements and combinations particularly pointed out in the appended claims.

It is to be understood that both the foregoing general description and the following detailed description are exemplary and explanatory only and are not restrictive of the invention.

### BRIEF DESCRIPTION OF THE DRAWINGS

FIG. 1 shows an XRPD pattern of gamma cyclodextrin.

FIG. 2 shows an ¹H NMR spectrum of uncomplexed gamma cyclodextrin.

FIG. 3 shows an ¹H NMR spectrum of gamma cyclodextrin complexed with rebaudioside D.

FIG. 4 shows an ¹H NMR spectrum of gamma cyclodextrin complexed with rebaudioside A.

FIG. 5 shows an ¹H NMR spectrum of gamma cyclodextrin complexed with rebaudioside C.

FIGS. 6a to 6d show DSC thermograms of uncomplexed gamma cyclodextrin, uncomplexed rebaudioside A, uncomplexed rebaudioside C, and uncomplexed rebaudioside D.

FIG. 7a shows a DSC thermogram of a physical mixture of gamma cyclodextrin with rebaudioside A.

FIG. 7b shows a DSC thermogram of gamma cyclodextrin-rebaudioside A inclusion complex.

FIG. 8a shows a DSC thermogram of a physical mixture of gamma cyclodextrin with rebaudioside C.

FIG. 8b shows a DSC thermogram of gamma cyclodextrin-rebaudioside C inclusion complex.

FIG. 9a shows a DSC thermogram of a physical mixture of gamma cyclodextrin with rebaudioside D.

FIG. 9b shows a DSC thermogram of gamma cyclodextrin-rebaudioside D inclusion complex.

FIG. 9c shows a DSC thermogram of homogenized gamma cyclodextrin-rebaudioside D inclusion complex.

FIG. 10a shows an infrared spectra of uncomplexed rebaudioside A.

FIG. 10b shows an infrared spectra of uncomplexed gamma cyclodextrin.

FIG. 11a shows four overlaid infrared spectra: uncomplexed gamma cyclodextrin, uncomplexed rebaudioside A, a physical mixture of gamma cyclodextrin with rebaudioside A, and a spectral addition of gamma cyclodextrin and rebaudioside A.

FIG. 11b shows an expanded view of the same spectra as above in the approximate region 1800-800 cm⁻¹.

FIG. 12a shows two overlaid infrared spectra: a physical mixture of gamma cyclodextrin with rebaudioside A and gamma cyclodextrin-rebaudioside A inclusion complex.

FIG. 12b shows an expanded view of the same spectra as above in the approximate region 1800-800 cm⁻¹.

FIG. 13 shows an infrared spectra of uncomplexed rebaudioside C.

FIG. 14a shows four overlaid infrared spectra: uncomplexed gamma cyclodextrin, uncomplexed rebaudioside C, a physical mixture of gamma cyclodextrin with rebaudioside C, and a spectral addition of gamma cyclodextrin and rebaudioside C.

FIG. 14b shows an expanded view of the spectra in FIG. 14a in the approximate region 1800-800 cm⁻¹.

FIG. 15a shows two overlaid infrared spectra: a physical mixture of gamma cyclodextrin with rebaudioside C and gamma cyclodextrin-rebaudioside C inclusion complex.

FIG. 15b shows an expanded view of the spectra in FIG. 15b in the approximate region 1800-800 cm⁻¹.

FIG. 16 shows an infrared spectra of uncomplexed rebaudioside D.

FIG. 17a shows four overlaid infrared spectra: uncomplexed gamma cyclodextrin, uncomplexed rebaudioside D, a physical mixture of gamma cyclodextrin with rebaudioside D, and a spectral addition of gamma cyclodextrin and rebaudioside D.

FIG. 17b shows an expanded view of the spectra in FIG. 17a in the approximate region 1800-800 cm⁻¹.

FIG. 18a shows two overlaid infrared spectra: a physical mixture of gamma cyclodextrin with rebaudioside D and gamma cyclodextrin-rebaudioside D inclusion complex.

FIG. 18b shows an expanded view of the spectra in FIG. 18a in the approximate region 1800-800 cm⁻¹.

FIG. 19a shows two overlaid infrared spectra: a physical mixture of gamma cyclodextrin with rebaudioside D and homogenized gamma cyclodextrin-rebaudioside D inclusion complex.

FIG. 19b shows an expanded view of the spectra in FIG. 19a in the approximate region 1800-800 cm⁻¹.

FIG. 20a shows three overlaid infrared spectra: uncomplexed rebaudioside D, homogenized gamma cyclodextrin-rebaudioside D inclusion complex and gamma cyclodextrin and rebaudioside D inclusion complex.

FIG. 20b shows an expanded view of the spectra in FIG. 20a in the approximate region 1800-800 cm⁻¹.

FIG. 21a shows a Raman spectra of uncomplexed rebaudioside A.

FIG. 21b shows a Raman spectra of uncomplexed gamma cyclodextrin.

FIGS. 22a and 22b show four overlaid Raman spectra: uncomplexed gamma cyclodextrin, uncomplexed rebaudioside A, a physical mixture of gamma cyclodextrin with rebaudioside A, and a spectral addition of gamma cyclodextrin and rebaudioside A.

FIG. 23 shows a Raman spectra of gamma cyclodextrin-rebaudioside A inclusion complex.

FIGS. 24a and 24b show two overlaid Raman spectra: a physical mixture of gamma cyclodextrin with rebaudioside A and gamma cyclodextrin-rebaudioside A inclusion complex.

FIG. 25 shows a Raman spectra of uncomplexed rebaudioside C.

FIGS. 26a and 26b shows four overlaid Raman spectra: uncomplexed gamma cyclodextrin, uncomplexed rebaudioside C, a physical mixture of gamma cyclodextrin with rebaudioside C, and a spectral addition of gamma cyclodextrin and rebaudioside C.

FIGS. 27a and 27b show two overlaid Raman spectra: a physical mixture of gamma cyclodextrin with rebaudioside C at 512 scans and at 256 scans.

FIG. 28 shows a Raman spectra of gamma cyclodextrin-rebaudioside C inclusion complex.

FIGS. 29a and 29b show two overlaid Raman spectra: a physical mixture of gamma cyclodextrin with rebaudioside C and gamma cyclodextrin-rebaudioside C inclusion complex.

FIG. 30 shows Raman spectra of uncomplexed rebaudioside D.

FIGS. 31a and 31b show four overlaid Raman spectra: uncomplexed gamma cyclodextrin, uncomplexed rebaudioside D, a physical mixture of gamma cyclodextrin with rebaudioside D, and a spectral addition of gamma cyclodextrin and rebaudioside D.

FIGS. 32a and 32b show two overlaid Raman spectra: a physical mixture of gamma cyclodextrin with rebaudioside Dat 512 scans and at 256 scans.

FIGS. 33a and 33b show two overlaid Raman spectra: a physical mixture of gamma cyclodextrin with rebaudioside D and gamma cyclodextrin-rebaudioside D inclusion complex.

FIGS. 34a and 34b show two overlaid Raman spectra: a physical mixture of gamma cyclodextrin with rebaudioside D and homogenized gamma cyclodextrin-rebaudioside D inclusion complex.

Reference will now be made in detail to the present embodiments and exemplary embodiments of the disclosure.

The disclosure provides an inclusion complex comprising a substantially pure terpene glycoside and at least one cyclodextrin, wherein the solubility of the inclusion complex is greater than the solubility of the at least one substantially pure terpene glycoside alone at room temperature. For example, the solubility of the at least one inclusion complex may be greater than 0.2%, such as greater than 1%, or greater than 1.5%, or greater than 2%, or greater than 2.5%, or greater than 3%, or greater than 3.5%, or greater than 4%, or greater than 4.5%, or greater than 5%. The disclosure also provides for an inclusion complex comprising at least two substantially pure terpene glycosides and at least one cyclodextrin.

For example, the substantially pure terpene glycoside can be chosen from rebaudioside A; rebaudioside B; rebaudioside C; rebaudioside D; rebaudioside E; rebaudioside F; stevioside; steviolbioside; dulcoside A; rubusoside; steviol; steviol 13 O-β-D-glycoside; suavioside A; suavioside B; suavioside G; suavioside H; suavioside I; suavioside J; isosteviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; β-[(2-O-β-D-glucopyranosyl-3-O-β-D-glucopyranosyl-βD-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; 1-[13-hydroxykaur-16-en-18-oate]β-D-glucopyranuronic acid; 13-[(2-O-β-D-glucopyranosyl-β-D-glucopyranosyl)oxy]-17-hydroxy-kaur-15-en-18-oic acid β-D-glucopyranosyl ester; 13-[(2-O-α-L-rhamnopyranosyl-3-O-β-D-glucopyranosyl-β-D-glucopyranosyl)oxy]kaur-16-en-18-oic acid-(2-O-β-D-glucopyranosyl-β-D-glucopyranosyl)ester; 13-[(2-O-β-D-glucopyranosyl-β-D-glucopyranosyl)oxy]-17-oxo-kaur-15-en-18-oic acid β-D-glucopyranosyl ester; 13-[(2-O-β-D-glucopyranosyl-β-D-glucopyranosyl)oxy]-17-oxo-kaur-15-en-18-oic acid β-D-glucopyranosyl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2-O-β-D-glucopyranosyl-β-D-glucopyranosyl)oxy]kaur-16-en-18-oic acid-(6-O-β-D-xylopyranosyl-β-D-glucopyranosyl)ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-β-D-glucopyranosyl)ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl)ester; 13-[(2-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid β-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-β-D-glucopyranosyl)oxy]kaur-16-en-18-oic acid β-D-glucopyranosyl ester; mogroside E; mogroside I A; mogroside I E; mogroside II A; mogroside II A₁; mogroside II B; mogroside II E; mogroside III; mogroside III A₂; mogroside IV; mogroside IV A; mogroside V; mogroside VI; 11-oxomogroside; 11-oxomogroside I A; 11-oxomogroside I A₁; 20-hydroxy-11-oxomogroside I A₁; 11-oxomogroside II A₁; 7-oxomogroside II E; 11-oxomogroside II E; 11-deoxymogroside III; 11-oxomogroside IV A; 7-oxomogroside V; 11-oxo-mogroside V; mogrol; 11-oxo-mogrol; siamenoside; siamenoside-1; isomogroside; isomogroside V; and polymorphic and amorphous forms thereof.

As used herein, purity is understood to mean the weight percentage of a terpene glycoside compound present in a terpene glycoside extract, in raw or purified form. As used herein, “substantially pure” is understood to mean greater than or equal to 95% pure. To obtain a substantially pure terpene glycoside, it may be necessary to purify a crude extract. Such purification methods are known to those of ordinary skill in the art. For example, an exemplary method of purifying a terpene glycoside, such as rebaudioside A, is described in U.S. Patent Application Publication No. 2007/0292582, the disclosure of which is incorporated herein by reference in its entirety.

As used herein, the term “polymorphism” is understood to mean the ability of a substance to exist as two or more crystalline states that have different arrangements and/or conformations of the molecules in a crystal lattice. Approximately 30% of compounds are believed to exhibit polymorphism. Polymorphism may cause physical properties, such as density, melting point, and rate of dissolution to change. Polymorphs may be identified by techniques well known to those of ordinary skill in the art, for example by analysis of powder x-ray diffraction (XRPD). For instance, a polymorphic form may be a solvate or hydrate. Those of ordinary skill in the art will appreciate that the aqueous organic solution and temperatures used in the purification process may, for example, influence the resulting polymorphs of a substance.

For example, in some embodiments a polymorph of stevioside may be used. At least two different polymorphic forms of stevioside may result from different purification methods. For example, Form 1: a stevioside hydrate and Form 2: a stevioside solvate (methanol solvate 2A and ethanol solvate 2B). A third polymorphic form of stevioside, an anhydrous stevioside, may also be used. Those of ordinary skill in the art will appreciate that organic solvents and/or aqueous organic solutions and/or the temperatures of a purification processes may influence the resulting polymorphs of a substantially pure stevioside composition. Such polymorphs are described, for example, in U.S. Patent Application Publication No. 2007/0292764, the disclosure of which is incorporated herein by reference in its entirety.

In some embodiments, a polymorph of rebaudioside A may be used, such as a hydrate or a solvate. The purification of rebaudioside A may result in the formation of different polymorphs of rebaudioside A. For example, Form 1: a rebaudioside A hydrate; Form 2: an anhydrous rebaudioside A; and Form 3: a rebaudioside A solvate. Those of ordinary skill in the art will appreciate that aqueous organic solutions and/or the temperatures of a purification process may influence the resulting polymorphs of a substantially pure rebaudioside A composition. In some embodiments, for example, an amorphous form of rebaudioside A may be used. Such polymorphous and amorphous forms are described, for example, in U.S. Patent Application Publication No. 2008/0292582.

In at least one embodiment, the substantially pure terpene glycoside is chosen from rebaudioside A, rebaudioside C, and rebaudioside D. In a further embodiment, the substantially pure terpene glycoside is rebaudioside A in a hydrate form.

To improve the solubility and dissolution properties of poorly soluble compounds or polymorphs, an inclusion complex with cyclodextrin can be formed. Cyclodextrins are cyclic oligosaccharides having at least six glucopyranose units. They generally form a toroid shape with an interior cavity that is less hydrophilic than the cyclodextrin exterior. They may form inclusion complexes and, as such, host other molecules. Cyclodextrins may change the physico-chemical properties of such other molecules, such as the solubility. As used herein, “cyclodextrin” refers to any cyclodextrin that increases the solubility of at least one substantially pure terpene glycoside.

For example, the at least one cyclodextrin may be chosen from ∝-cyclodextrin, β-cyclodextrin, γ-cyclodextrin, and derivatives thereof. In some embodiments, the at least one cyclodextrin is chosen from ∝-cyclodextrin, β-cyclodextrin, γ-cyclodextrin. In an embodiment, the at least one cyclodextrin is γ-cyclodextrin. Any of the provided cyclodextrins or their derivatives may be used for preparation of the inclusion complexes either alone or in the form of a mixture of one or more cyclodextrins.

For example, the inclusion complex of the disclosure may comprise at least one cyclodextrin derivative. For instance, a cyclodextrin derivative may have modified or substituted hydroxyl groups located on the exterior or interior cavity of the cyclodextrin. Non-limiting examples of such cyclodextrin derivatives include alkylated cyclodextrins; hydroxyalkylated cyclodextrins; ethylcarboxymethyl cyclodextrins; sulfonated and sulfoalkylether cyclodextrins; cyclodextrins substituted with ammonium groups, phosphate groups, and hydroxyl groups, and salts thereof; fluorinated cyclodextrins; and cyclodextrins substituted with saccharides. Derivatives are generally prepared by modifying or substituting the hydroxyl groups located on the exterior or interior of the cyclodextrin. The modifications may be made to increase the aqueous solubility and stability of the inclusion complex. Modifications may also be made to alter the physical characteristics of the complex. Modifications of those types and others are well known in the art.

For example, a commercially available cyclodextrin may be used, for example, those sold by the companies Cyclolab Ltd., those sold under the trade name TRAPPSOL® by CDT, Inc., those sold under the trade name CAVAMAX® by Wacker, those sold under the tradenames KLEPTOSE® and CRYSMEB® by Roquette, and those sold under the tradename CAPTISOL® by CYDEX Pharmaceuticals.

The substantially pure terpene glycoside and the at least one cyclodextrin form an inclusion complex. As used herein, the term “inclusion complex” is understood to mean that the substantially pure terpene glycoside and cyclodextrin are in intimate contact with one another, such as a complete or partial association or contact between substantially pure terpene glycoside and cyclodextrin, which may not necessarily form an inclusion complex all the time.

For example, when the substantially pure terpene glycoside is present in an amount exceeding that which can be incorporated into an inclusion complex using at least one cyclodextrin, the substantially pure terpene glycoside may be present in a free form. Such free substantially pure terpene glycosides are also within the scope of the disclosure. The amount of such free or uncomplexed substantially pure terpene glycoside may be determined by the amount and type of cyclodextrin, the complexation capacity or the concentration desired, the process utilized to prepare the inclusion complexes, and other parameters known to a person of ordinary skill in the art.

In at least one embodiment, the aqueous solubility of the substantially pure terpene glycoside is increased when in the form of an inclusion complex. In accordance with the disclosure, the solubility of the substantially pure terpene glycoside is increased, such that more substantially pure terpene glycoside, whether free or in an inclusion complex, is capable of dissolving in an aqueous composition than substantially pure terpene glycoside not in the presence of cyclodextrin.

For example, the aqueous solubility may be range from 0.1% to 7%, for example from 0.2% to 7%, such as from 0.2% to 5%. In some embodiments, the aqueous solubility may range from 0.5% to 7%, such as from 1% to 5%, or from 2% to 5%, or from 3% to 5%, or from 4% to 5%.

In some embodiments, the ratio of substantially pure terpene glycoside to cyclodextrin ranges from 1:1 to 1:20. For example, the ratio may range from 1:1 to 1:19, or from 1:1 to 1:15 or from 1:1 to 1:9, or from 1:1 to 1:8, or from 1:1 to 1:7, or from 1:1 to 1:6, or from 1:1 to 1:5, or from 1:1 to 1:4.

Another aspect of the disclosure is a composition, such as an orally ingestible composition, for example a beverage composition, comprising at least one inclusion complex comprising a substantially pure terpene glycoside and at least one cyclodextrin, wherein the solubility of the inclusion complex is greater than the solubility of the substantially pure terpene glycoside alone.

In at least one embodiment, the composition comprises at least one cyclodextrin chosen from ∝-cyclodextrin, β-cyclodextrin, γ-cyclodextrin, and derivatives thereof. For example, the cyclodextrin may be γ-cyclodextrin.

For example, the substantially pure terpene glycoside may be present in the composition in an amount ranging from 0.2% to 7%, by weight relative to the total weight of the composition. In at least one embodiment, the at least one substantially pure terpene glycoside is present in an amount ranging from 0.5% to 5%, by weight relative to the total weight of the composition, such as from 1% to 5%, or from 2% to 5%, or from 3% to 5%.

In some embodiments, the composition has improved taste. For example, the composition may be less bitter and/or have no or reduced lingering aftertaste. In some embodiments, a composition comprising an inclusion complex according to the disclosure has a more sugar like taste and/or a less metallic taste than a composition comprising at least one terpene glycoside without the inclusion complex. For example, the taste may be perceived as cleaner with fewer metallic notes. In at least one embodiment, the composition comprising an inclusion complex according to the disclosure has a more rapid taste onset than a composition comprising at least one terpene glycoside without the inclusion complex.

Generally, the amount of inclusion complex of the disclosure in a composition may vary widely depending on the type of composition and its desired properties, such as sweetness. Those of ordinary skill in the art can readily discern the appropriate amount of inclusion complex to put in compositions of the disclosure.

As used herein, “orally ingestible composition” is understood to mean substances which are contacted with the mouth of man or animal, including substances which are taken into and subsequently ejected from the mouth and substances which are drunk, eaten, swallowed or otherwise ingested, and are safe for human or animal consumption when used in a generally acceptable range. These compositions include, for example, food, beverage, tobacco, nutraceutical, oral hygienic/cosmetic products, and the like. Non-limiting examples of these products include non-carbonated and carbonated beverages such as colas, ginger ales, root beers, ciders, fruit-flavored soft drinks (e.g., citrus-flavored soft drinks such as lemon-lime or orange), powdered soft drinks, and the like; fruit juices originating from fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or synthetic flavorants); tea type or favorite type beverages such as coffee, cocoa, black tea, green tea, oolong tea and the like; beverages containing milk components such as milk beverages, coffee containing milk components, cafe au lait, milk tea, fruit milk beverages, drinkable yogurt, lactic acid bacteria beverages or the like; dairy products; bakery products; desserts such as yogurt, jellies, drinkable jellies, puddings, Bavarian cream, blancmange, cakes, brownies, mousse and the like, sweetened food products eaten at tea time or following meals; frozen foods; cold confections, e.g., types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); ice cream; general confections, e.g., baked confections or steamed confections such as cakes, crackers, biscuits, buns with bean-jam filling and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans and the like; sauces including fruit flavored sauces, chocolate sauces and the like; edible gels; cremes including butter cremes, flour pastes, whipped cream and the like; jams including strawberry jam, marmalade and the like; breads including sweet breads and the like or other starch products; spice; general condiments including seasoned soy sauce used on roasted meats, roast fowl, barbecued meat and the like, as well as tomato catsup, sauces, noodle broth and the like; processed agricultural products, livestock products or seafood; processed meat products such as sausage and the like; retort food products, pickles, preserves boiled in soy sauce, delicacies, side dishes; snacks such as potato chips, cookies, or the like; cereal products; drugs or quasi-drugs that are administered orally or used in the oral cavity (e.g., vitamins, cough syrups, cough drops, chewable medicine tablets, amino acids, bitter-tasting drug or pharmaceutical agents, acidulants or the like), wherein the drug may be in solid, liquid, gel, or gas form such as a pill, tablet, spray, capsule, syrup, drop, troche agent, powder, and the like; personal care products such as other oral compositions used in the oral cavity such as mouth freshening agents, gargling agents, mouth rinsing agents, toothpaste, tooth polish, dentrifices, mouth sprays, teeth-whitening agents and the like; dietary supplements; tobacco products including smoke and smokeless tobacco products such as snuff, cigarette, pipe and cigar tobacco, and all forms of tobacco such as shredded filler, leaf, stem, stalk, homogenized leaf cured, reconstituted binders and reconstituted tobacco from tobacco dust, fines or ether sources in sheet, pellet or other forms, tobacco substitutes formulated from non-tobacco materials, dip or chewing tobacco; animal feed; and nutraceutical products, which includes any food or part of a food that may provide health benefits.

In at least one embodiment, an orally ingestible composition is a beverage, such as a carbonated or noncarbonated beverage, comprising at least one inclusion complex comprising a substantially pure terpene glycoside and at least one cyclodextrin. For example, in some embodiments at least one inclusion complex according to the disclosure is present in an orally ingestible composition in an amount ranging from 0.1% to 7%, by weight relative to the total weight of the composition.

In addition, those of ordinary skill in the art should appreciate that the composition can be customized to obtain a desired caloric content. For example, the at least one inclusion complex of the disclosure may be combined with at least one other sweetener, such as a low-caloric or non-caloric synthetic sweetener, and/or other additives to produce an orally ingestible composition with a preferred calorie content and/or taste.

For example, the compositions of the disclosure may further comprise at least one other sweetener. The at least one other sweetener may be any type of sweetener, for example a natural or synthetic sweetener. In at least one embodiment, the at least one other sweetener is chosen from natural sweeteners. In another embodiment, the at least one other sweetener is chosen from synthetic sweeteners. In some embodiments, the composition comprises at least two other sweeteners.

For example, the at least one other sweetener may be a caloric carbohydrate sweetener. Non-limiting examples of suitable caloric carbohydrate sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigero-oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (HFCS) (e.g., HFCS55, HFCS42, or HFCS90), coupling sugars, soybean oligosaccharides, and glucose syrup.

For example, the at least one other sweetener may be a synthetic sweetener. As used herein, the phrase “synthetic sweetener” refers to any composition which is not found naturally in nature and characteristically has a sweetness potency greater than sucrose, fructose, or glucose, yet have less calories. Non-limiting examples of synthetic sweeteners suitable for embodiments of this disclosure include sucralose, potassium acesulfame, aspartame, alitame, saccharin, neohesperidin dihydrochalcone, cyclamate, neotame, N-[N-[3-(3-hydroxy-4-methoxyphenyl)propyl]-L-α-aspartyl]-L-phenylalanine 1-methyl ester, N-[N-[3-(3-hydroxy-4-methoxyphenyl)-3-methylbutyl]-L-α-aspartyl]-L-phenylalanine 1-methyl ester, N-[N-[3-(3-methoxy-4-hydroxyphenyl)propyl]-L-α-aspartyl]-L-phenylalanine 1-methyl ester, salts thereof, and the like.

Other sweeteners suitable for use in embodiments provided herein, for example, include natural and synthetic high-potency sweeteners. As used herein the phrases “natural high-potency sweetener”, “NHPS”, “NHPS composition”, and “natural high-potency sweetener composition” are synonymous. “NHPS” means any sweetener found in nature which may be in raw, extracted, purified, or any other form, singularly or in combination thereof and characteristically have a sweetness potency greater than sucrose, fructose, or glucose, yet have less calories. Non-limiting examples of NHPSs suitable for embodiments of this disclosure include rebaudioside A, rebaudioside B, rebaudioside C (dulcoside B), rebaudioside D, rebaudioside E, rebaudioside F, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I. NHPS also includes modified NHPSs. Modified NHPSs include NHPSs which have been altered naturally. For example, a modified NHPS includes, but is not limited to, NHPSs which have been fermented, contacted with enzyme, or derivatized or substituted on the NHPS. In one embodiment, at least one modified NHPS may be used in combination with at least one NHPS. In another embodiment, at least one modified NHPS may be used without a NHPS. Thus, modified NHPSs may be substituted for a NHPS or may be used in combination with NHPSs for any of the embodiments described herein. For the sake of brevity, however, in the description of embodiments, a modified NHPS is not expressly described as an alternative to an unmodified NHPS, but it should be understood that modified NHPSs can be substituted for NHPSs in any embodiment disclosed herein.

In at least one embodiment, the composition of the disclosure comprises at least one additional additive.

For example, the composition of the disclosure may comprise at least one sweet taste improving additive and/or composition for re-balancing the temporal and/or flavor profile of the composition. The use of sweet taste improving additives and/or compositions to improve the temporal and/or flavor profile of sweetener compositions are described in detail in co-pending U.S. patent application Ser. Nos. 11/561,148, 11/561,158, and U.S. Patent Application Publication No. 2008/0292765, the disclosures of which are incorporated herein by reference in their entirety.

For example, suitable sweet-taste improving additives and/or compositions include, but are not limited to, carbohydrates, polyols, amino acids and salts thereof, polyamino acids and salts thereof, peptides, sugar acids and salts thereof, nucleotides and salts thereof, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, flavonoids, alcohols, polymers, other sweet taste improving taste additives imparting such sugar-like characteristics, natural high potency sweeteners, and combinations thereof.

As used herein, the phrase “sweet taste improving additive” means any material that imparts a more sugar-like temporal profile or sugar-like flavor profile or both to a synthetic sweetener added to compositions of the present disclosure.

Suitable sweet taste improving amino acid additives for use in embodiments of this disclosure include, but are not limited to, aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (α-, β-, or γ-isomers), glutamine, hydroxyproline, taurine, norvaline, sarcosine, and their salt forms such as sodium or potassium salts or acid salts. The sweet taste improving amino acid additives also may be in the D- or L-configuration and in the mono-, di-, or tri-form of the same or different amino acids. Additionally, the amino acids may be α-, β-, γ-, δ-, and ε-isomers if appropriate. Combinations of the foregoing amino acids and their corresponding salts (e.g., sodium, potassium, calcium, magnesium salts or other alkali or alkaline earth metal salts thereof, or acid salts) also are suitable sweet taste improving additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable sweet taste improving polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The sweet taste improving polyamino acid additives also may be in the D- or L-configuration. Additionally, the polyamino acids may be α-, β-, γ-, δ-, and ε-isomers if appropriate. Combinations of the foregoing polyamino acids and their corresponding salts (e.g., sodium, potassium, calcium, magnesium salts or other alkali or alkaline earth metal salts thereof or acid salts) also are suitable sweet taste improving additives in some embodiments. The polyamino acids described herein also may comprise co-polymers of different amino acids. The polyamino acids may be natural or synthetic. The polyamino acids also may be modified, such that at least one atom has been added, removed, substituted, or combinations thereof (e.g., N-alkyl polyamino acid or N-acyl polyamino acid). As used herein, polyamino acids encompass both modified and unmodified polyamino acids. For example, modified polyamino acids include, but are not limited to polyamino acids of various molecular weights (MW), such as poly-L-α-lysine with a MW of 1,500, MW of 6,000, MW of 25,200, MW of 63,000, MW of 83,000, or MW of 300,000.

Suitable sweet taste improving sugar acid additives include, for example, but are not limited to aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

For example, suitable sweet taste improving nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable sweet taste improving organic acid additives include any compound which comprises a —COOH moiety. Suitable sweet taste improving organic acid additives, for example, include but are not limited to C2-C30 carboxylic acids, substituted hydroxyl C2-C30 carboxylic acids, benzoic acid, substituted benzoic acids (e.g., 2,4-dihydroxybenzoic acid), substituted cinnamic acids, hydroxyacids, substituted hydroxybenzoic acids, substituted cyclohexyl carboxylic acids, tannic acid, lactic acid, tartaric acid, citric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

For example, suitable sweet taste improving organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), and adipic acid. The examples of the sweet taste improving organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phospho, phosphonato, and any other viable functional group provided the substituted organic acid additives function to improve the sweet taste of a synthetic sweetener.

For example, suitable sweet taste improving inorganic acid additives include but are not limited to phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable sweet taste improving bitter compound additives, for example, include but are not limited to caffeine, quinine, urea, bitter orange oil, naringin, quassia, and salts thereof.

Another aspect of the disclosure relates to methods for increasing the solubility of a substantially pure terpene glycoside, comprising combining a substantially pure terpene glycoside with at least one cyclodextrin to form at least one inclusion complex, wherein the solubility of the at least one inclusion complex is greater than the solubility of the substantially pure terpene glycoside alone.

Various methods are known in the art to form inclusion complexes. The inclusion complex of the disclosure may be formed by any method known to those skilled in the art. For example, the inclusion complex may be formed by freeze drying, co-precipitating, grinding, stirring with heating, and kneading. Exemplary methods of forming cyclodextrin inclusion complexes are described in U.S. Patent Application Publication No. 2009/0012146.

For example, the inclusion complex may be formed by freeze-drying. For example, in one method, equimolar amounts of substantially pure terpene glycoside and cyclodextrin are dissolved in water in amounts of 1 to 5 parts and heated with stirring up to 60° C. To this 95% ethanol (or another alcohol such as methanol or a mixture of alcohols) is added drop-wise until the solution starts to become clear. Once the solution is clear, it is cooled to room temperature and then freeze dried for 48 hours. In some cases methanol may be used.

In one embodiment, the inclusion complex is combined with an orally ingestible composition, such as a beverage composition. In some embodiments, the beverage composition is carbonated or noncarbonated.

The substantially pure terpene glycoside may be combined with at least one cyclodextrin before or after being added to an orally ingestible composition. For example, a substantially pure terpene glycoside and at least one cyclodextrin may form a complex before or after being added to an orally ingestible composition, such as after. For instance, rebaudioside A and gamma cyclodextrin may be complexed before being added to an orally ingestible composition. The inclusion complex may be in a pure, diluted, or concentrated form as a liquid (e.g., solution), solid (e.g., powder, chunk, pellet, grain, block, crystalline, or the like), or suspension.

Another aspect of the disclosure relates to a method of improving the taste of an orally ingestible composition. In one embodiment, a method of improving the taste of an orally ingestible composition comprises adding an inclusion complex of the disclosure to an orally ingestible composition.

In some embodiments, when there are more than one inclusion complex, each complex may be added simultaneously, in an alternating pattern, in a random pattern, or any other pattern to an orally ingestible composition.

In some embodiments of the disclosure, the composition is a table-top sweetener composition comprising at least one inclusion complex comprising a substantially pure terpene glycoside and at least one cyclodextrin, at least one bulking agent, and optionally at least one sweet taste improving composition and/or anti-caking agent with improved temporal and/or flavor profile.

For example, suitable “bulking agents” include, but are not limited to maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and mixtures thereof. Additionally, the at least one bulking agent is chosen from, granulated sugar (sucrose) or other caloric sweeteners such as crystalline fructose, other carbohydrates, and sugar alcohols. In one embodiment, a bulking agent may be used as a sweet taste improving composition.

In at least one embodiment, the table top sweetener of the disclosure comprises at least one sucrose, such as at least one sucrose polyol.

As used herein the phrase “anti-caking agent” is understood to mean any composition which prevents, reduces, inhibits, or suppresses at least one sweetener molecule from attaching, binding, or contacting to another sweetener molecule. Alternatively, “anti-caking agent” may refer to any composition which assists in content uniformity and uniform dissolution. In accordance with some embodiments, non-limiting examples of anti-caking agents include cream of tartar, calcium silicate, silicon dioxide, microcrystalline cellulose (Avicel, FMC BioPolymer, Philadelphia, Pa.), and tricalcium phosphate. In at least one embodiment, the anti-caking agents are present in the tabletop sweetener composition in an amount from about 0.001 to about 3% by weight of the tabletop sweetener composition.

Tabletop sweetener compositions may be embodied and packaged in numerous different forms, and may be of any form known in the art. For example, and not by way of limitation, the tabletop sweetener compositions may be in the form of powders, granules, packets, tablets, sachets, pellets, cubes, solids, or liquids.

Notwithstanding that the numerical ranges and parameters setting forth the broad scope of the disclosure are approximations, unless otherwise indicated the numerical values set forth in the specific examples are reported as precisely as possible. Any numerical value, however, inherently contains certain errors necessarily resulting from the standard deviation found in their respective testing measurements.

By way of non-limiting illustration, concrete examples of certain embodiments of the present disclosure are given below.

### EXAMPLES

### Example 1

### XRPD of Cyclodextrin

An X-ray powder diffraction (XRPD) pattern was collected for the cyclodextrin sample. The sample was analyzed using a PANalytical X'Pert PRO MPD diffractometer with an incident beam of Cu radiation produced using an Optix long, fine-focus source. An elliptically graded multilayer mirror was used to focus Cu Kα X-rays through the specimen and onto the detector. Prior to the analysis, a silicon specimen (NIST SRM 640c) was analyzed to verify the Si 111 peak position. A specimen of the sample was sandwiched between 3 μm-thick films and analyzed in transmission geometry. A beam-stop was used to minimize the background generated by air. Soller slits for the incident and diffracted beams were used to minimize broadening from axial divergence. Diffraction patterns were collected using a scanning position-sensitive detector (X'Celerator) located 240 mm from the specimen and Data Collector software v. 2.2b. The data-acquisition parameters for each pattern are displayed above the image in the Data section of this report including the divergence slit (DS) before the mirror and the incident-beam antiscatter slit (SS).

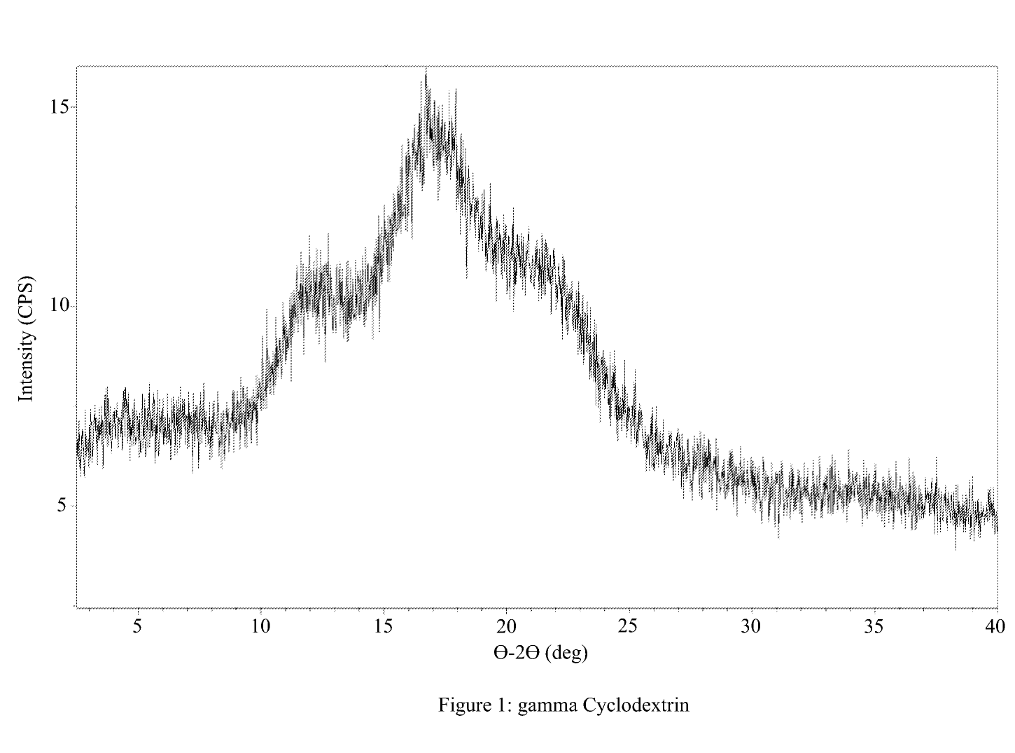

XRPD analysis on gamma cyclodextrin confirmed its amorphous character, as provided in FIG. 1.

### Example 2

### Preparation of Inclusion Complex

A. γ-CD and Reb A (Hydrate Form) Complex:

Equimolar amounts of a hydrate form of Rebaudioside (“Reb”) A was combined with one mmol of γ-cyclodextrin (γ-CD) and suspended in water (10 mL). This solution was heated with stirring up to 67° C. To this was added 95% ethanol drop-wise until the solution started to become clear, within 5 minutes (1.5 mL). Once the solution was clear, it was cooled to room temperature and then freeze-dried for 48 hours.

B. γ-CD and Reb C Complex

Equimolar amounts of Reb C was combined with one mmol γ-cyclodextrin and suspended in water (10 mL). The solution was heated with stirring up to 67° C. To this was added 95% ethanol drop-wise till the solution started to become clear, within 5 minutes (3.0 mL). Once the solution was clear, it was cooled to room temperature and then freeze-dried for 48 hours.

C. γ-CD and Reb D Complex A

Equimolar amounts of Reb D was combined with one mmol γ-cyclodextrin and suspended in water (30 mL), methanol (30 mL) and ethanol (10 mL) and was heated with vigorous stirring up to 60° C. for 30 minutes. Once the solution was clear, it was cooled to room temperature and then freeze-dried for 48 hours.

γ-CD and Reb D Complex B

In this case, the solution after stirring from above example C was passed through a homogenizer at 120 K Psi and then freeze dried. The idea was to later on see if homogenization breaks up some of the electronic interactions that stabilize the inclusion complexes.

### Example 3

### NMR DATA

¹H NMR spectra were obtained of the samples prepared in Example 2 and compared with a cyclodextrin solution comprising no terpene glycoside. ¹H NMR analysis was performed on a Varian unity 600 operating at 600 MHz. Samples were dissolved in deuterium oxide at a concentration of 3-4 mol/Lx. The chemical shift at 4.7 ppm due to traces of water present in the solvent was used as a reference. Typical parameters for 1H NMR spectra were 64 scans, 1 s relaxation delay and 45 degree pulse angle.

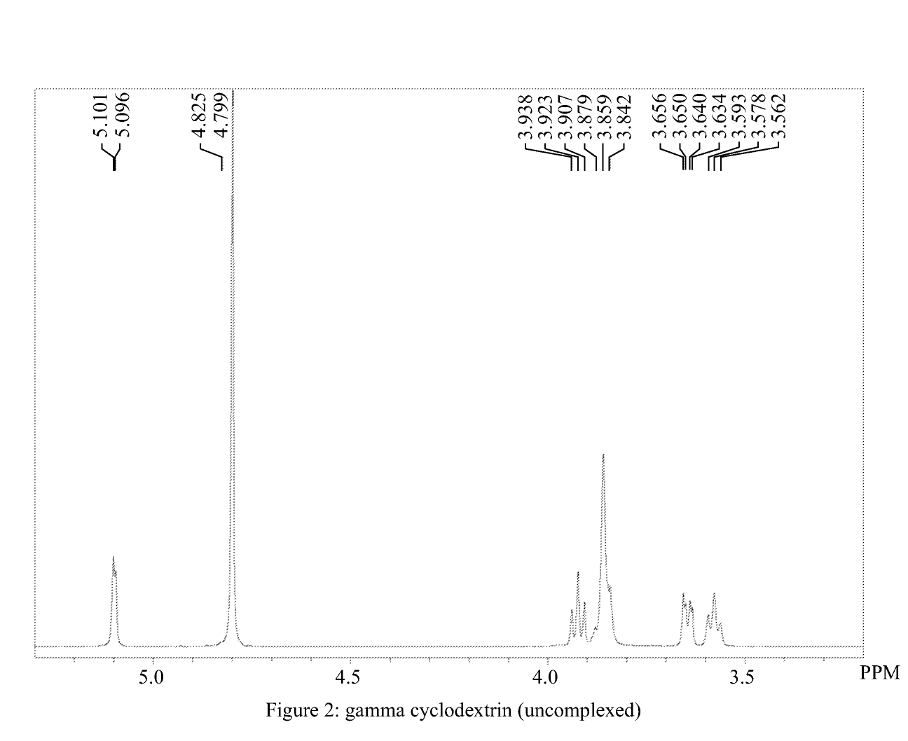

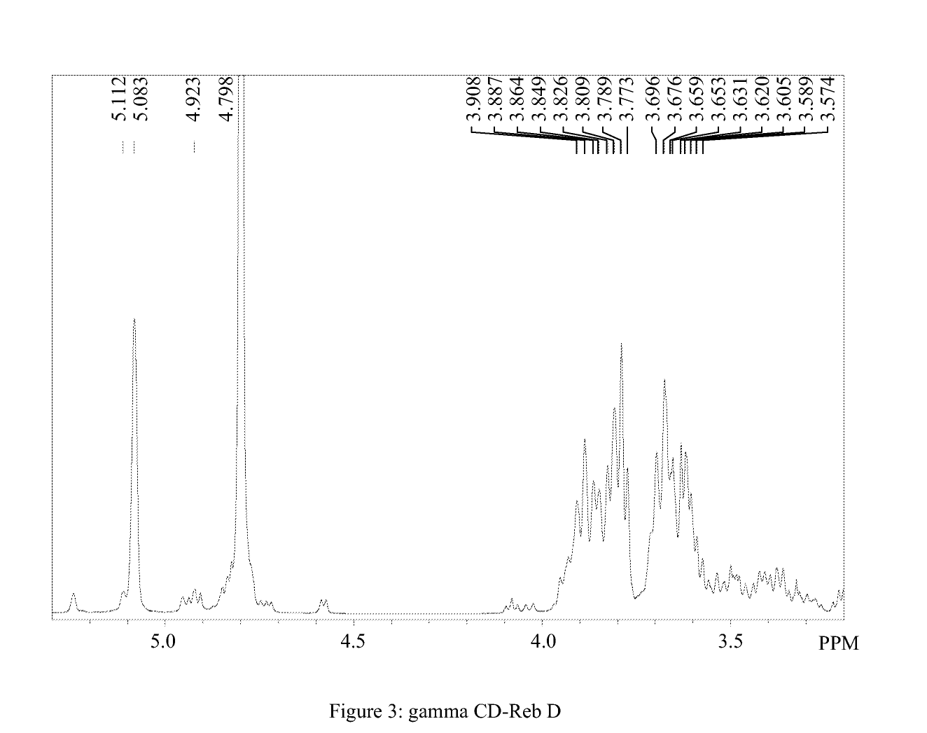

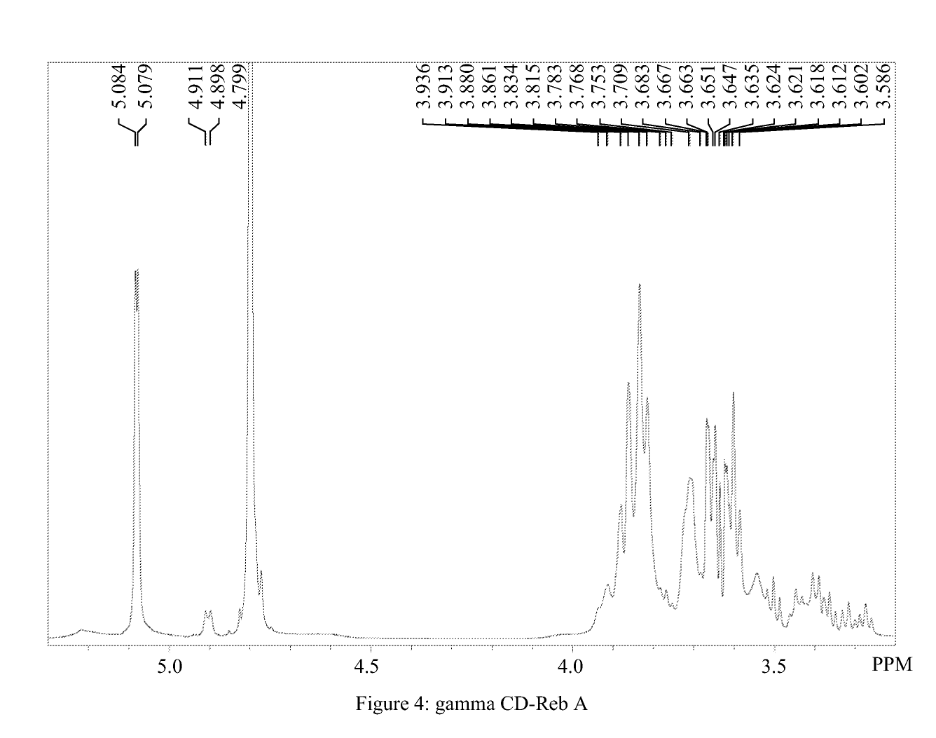

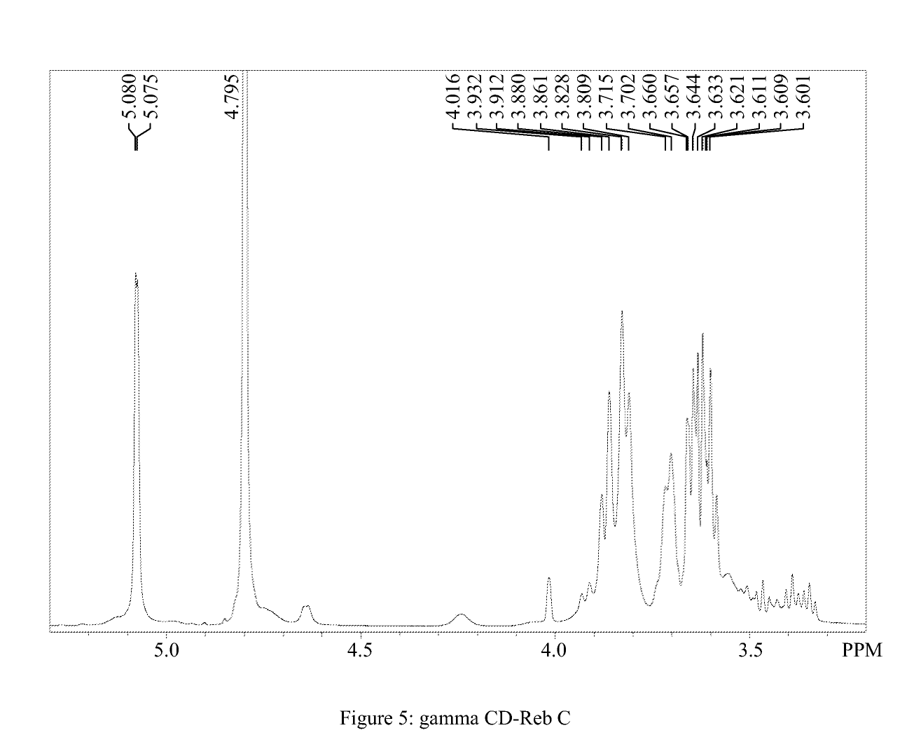

To determine whether an inclusion complex was formed, the proton shifts in the range of from 5.3 ppm to 3.2 ppm of the reference sample (FIG. 2), were compared to solutions prepared in Example 2 (FIGS. 3-5). It can be seen in FIGS. 3-5 that those protons showed upfield chemical shifts due to shielding by the guest molecule. That is consistent with the formation of an inclusion complex for the preparations described in Example 2.

### Example 4

### DSC Data

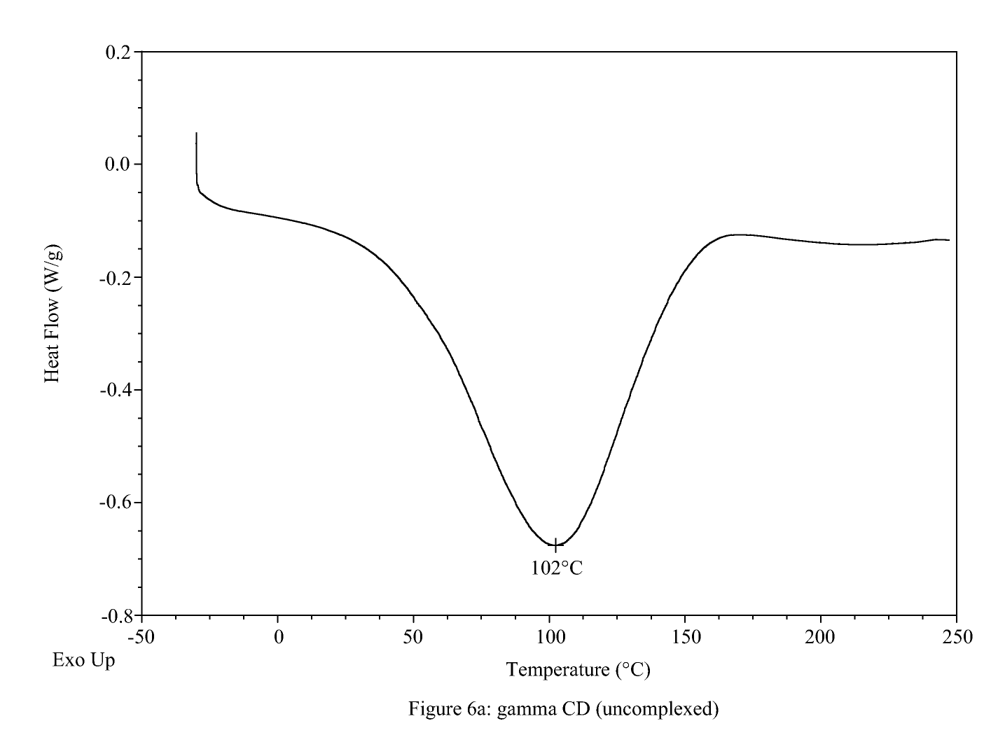

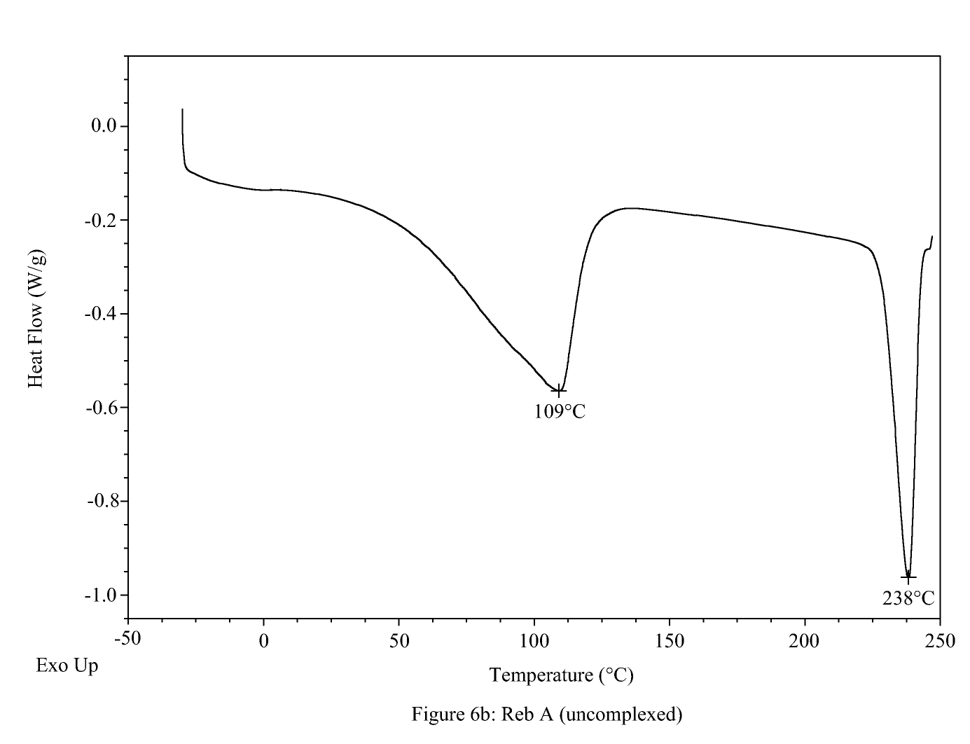

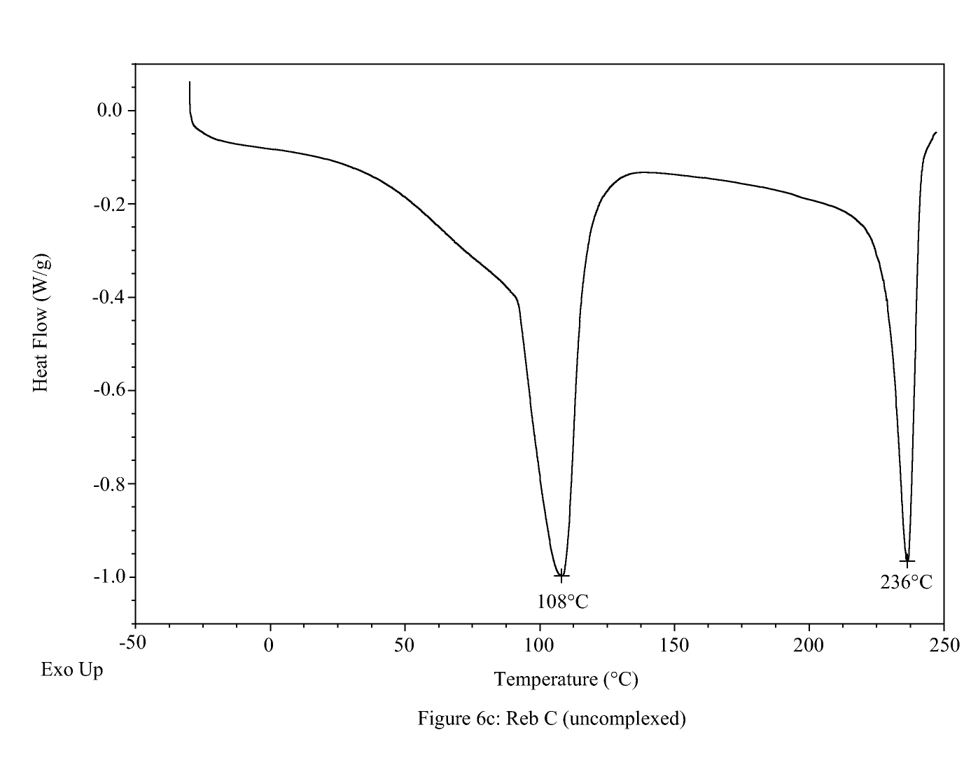

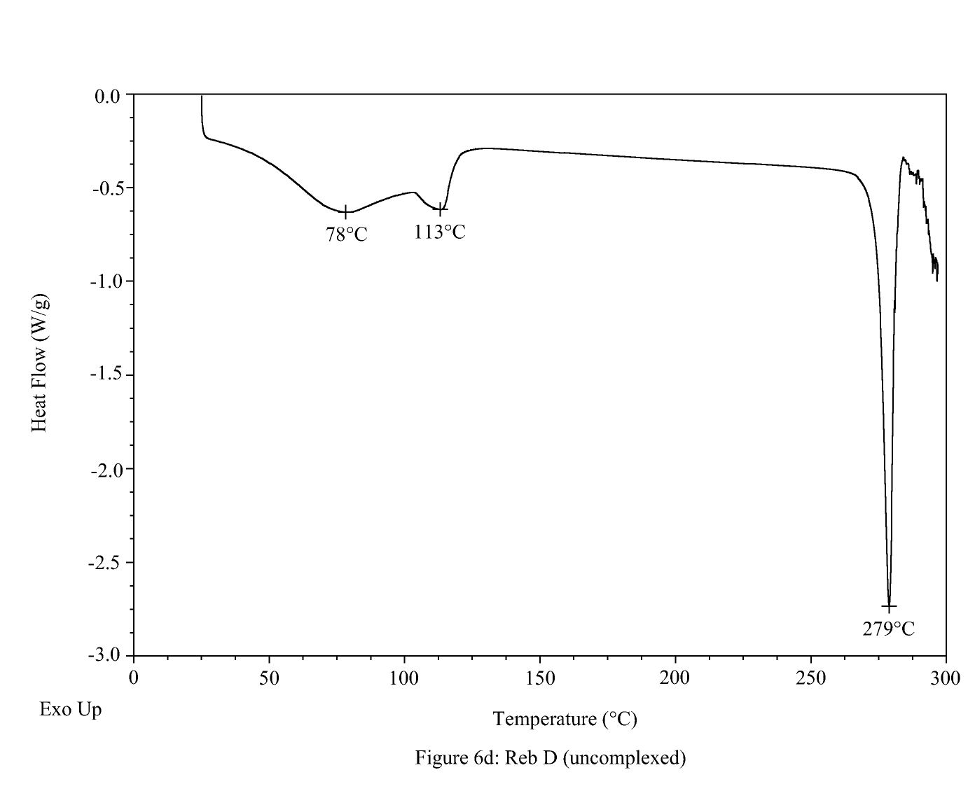

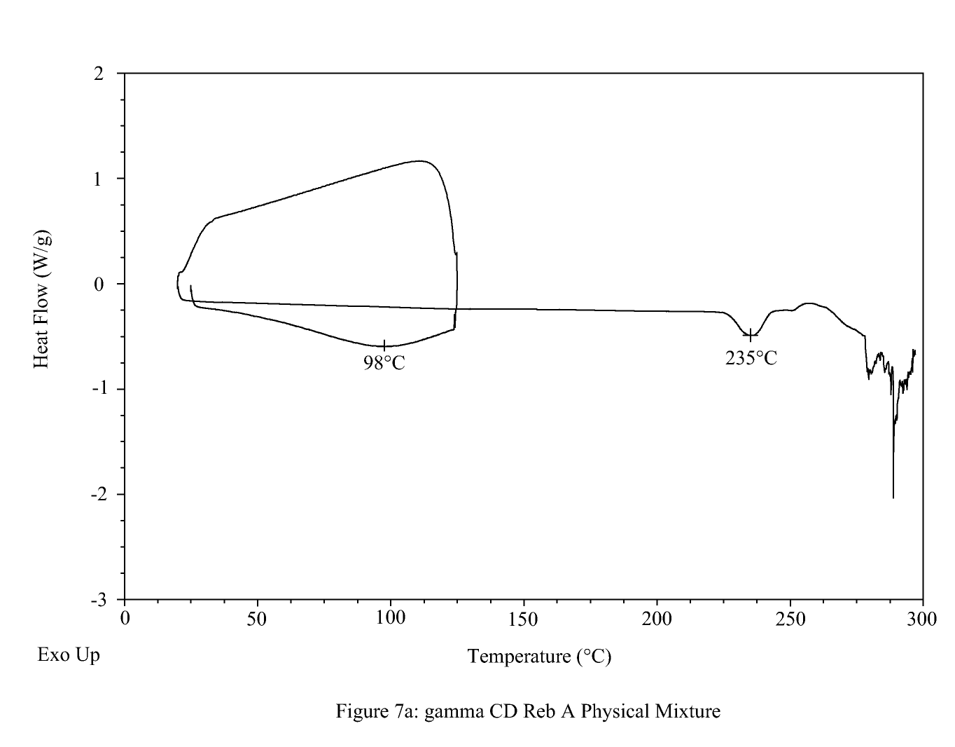

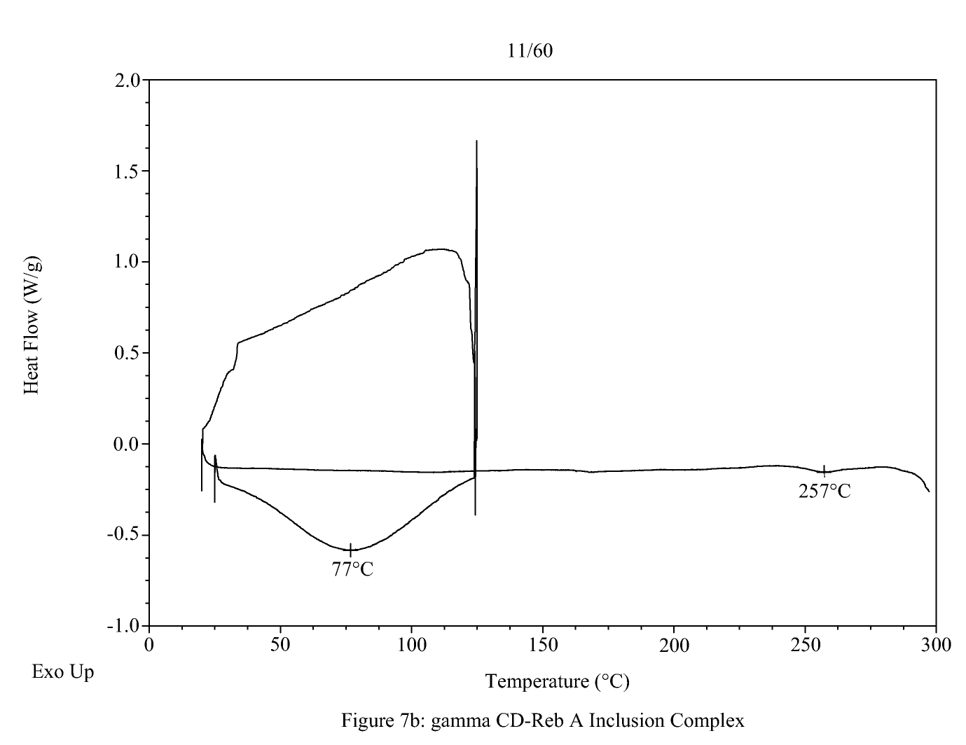

Differential scanning calorimetry (DSC) was performed on uncomplexed components of inclusion complexes (FIGS. 6a-d) and physical mixtures and inclusion complexes (FIGS. 7-9). DSC was performed using a TA Instruments Q2000 differential scanning calorimeter. Temperature calibration was performed using NIST traceable indium metal. The sample was placed into an aluminum DSC pan, covered with a lid, and the weight was accurately recorded. Pan lids were manually perforated with a pinhole for all samples except Rebaudioside A, C, and D. A weighed aluminum pan configured as the sample pan was placed on the reference side of the cell. Cyclodextrin and the steviol glycosides were heated from −30° C. to either 250 or 300° C. at 10° C./min. Inclusion complexes and physical mixtures were heated from ambient to 125° C. at 10° C./min, held isothermal for one minute at 125° C., rapidly cooled to 20° C., and then heated to 300° C. at 10° C./min.

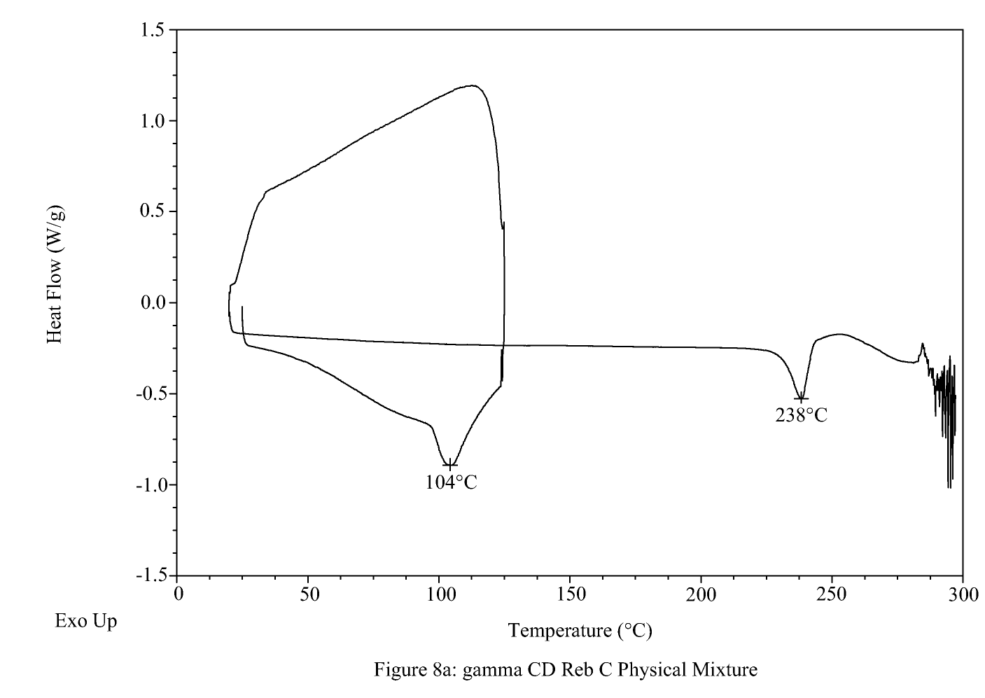

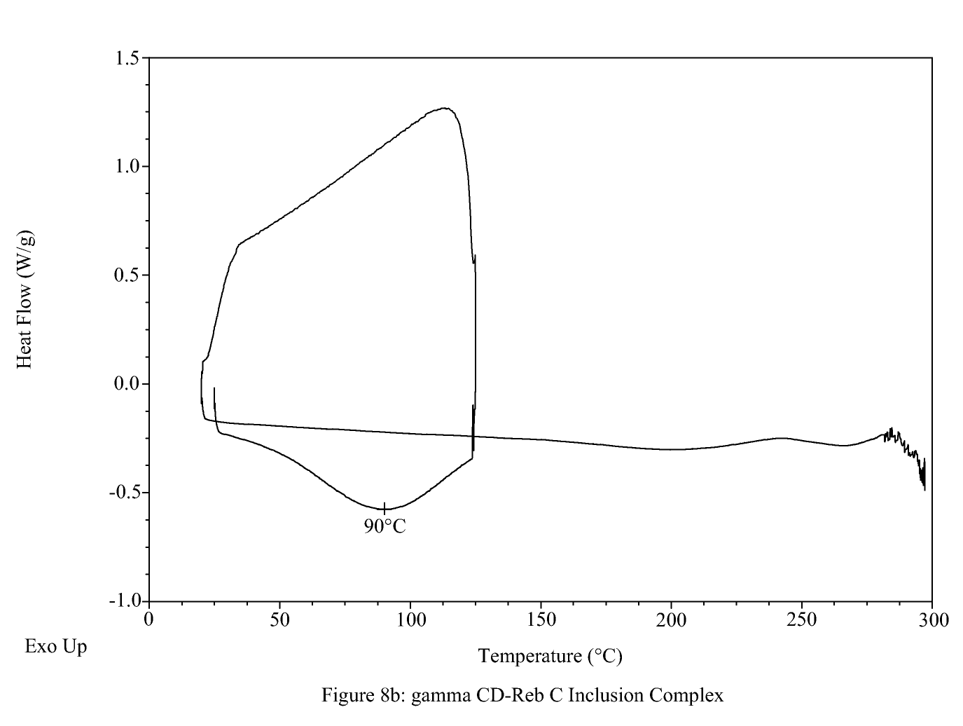

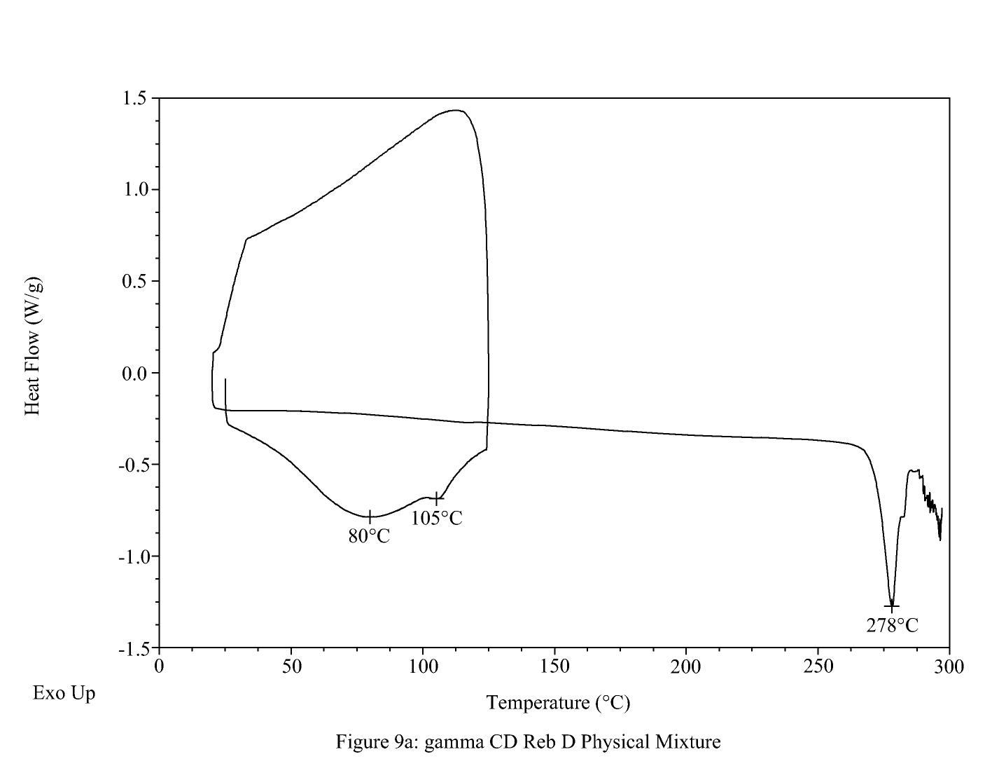

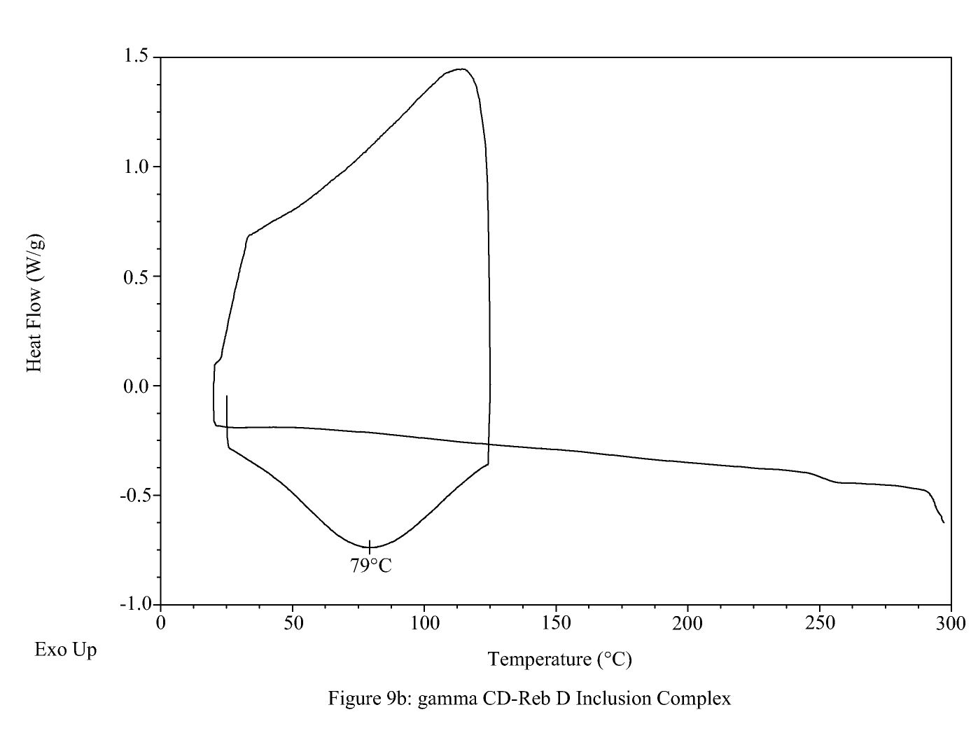

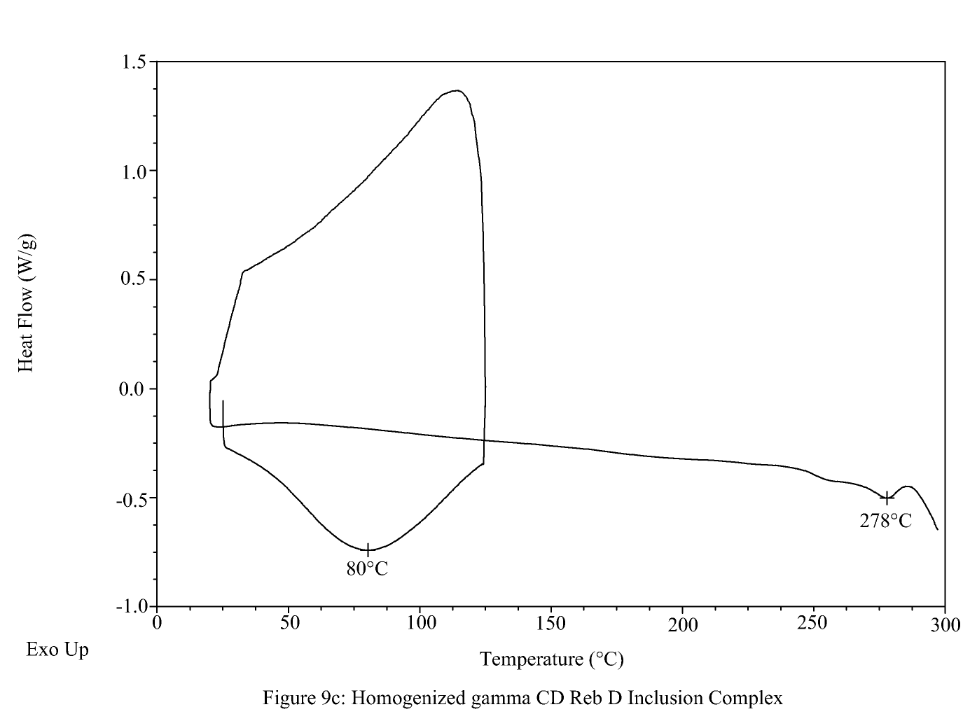

FIGS. 6a to 9c display results of DSC analyses. The first heating cycle for each sample displays a broad endotherm spanning from ambient temperature to the end of cycle near 125° C., consistent with loss of adsorbed water from the hygroscopic samples. An overlapping endothermic peak is observed near 100° C. in the physical mixture of rebaudioside C with gamma cyclodextrin (FIG. 8a) and rebaudioside D with gamma cyclodextrin (FIG. 9a). This second thermal event near 100° C. has not been assigned for the physical mixtures. Without wishing to be bound to a particular theory, its endothermic character suggests it may potentially be attributable to the presence of crystalline material in the samples (for example, a solid-solid transition or melt), or an enthalpic relaxation of the amorphous material. Without wishing to be bound to a particular theory, the absence of the endothermic peak near 100° C. in the thermograms of the inclusion complexes (FIG. 8b and FIG. 9b) is consistent with the presence of a stabilizing interaction hindering crystallization of the steviol glycosides, whether occurring during or prior to the DSC analyses, and indicates that a complex of cyclodextrin and rebaudioside C is present.

The second heating cycle for each physical mixture (FIGS. 7a, 8a, and 9a) displays a strong endothermic peak above 200° C. (below decomposition). Without wishing to be bound to a particular theory, this endothermic peak appears similar in temperature to a peak assigned to melting in the thermogram of each corresponding steviol glycoside. In contrast, the second heating cycles for the inclusion complexes display only broad, relatively weak, thermal events prior to decomposition.

Without wishing to be bound to a particular theory, the absence of a strong endothermic melting peak above 200° C. in the thermograms of the inclusion complexes (FIG. 7b, FIG. 8b, and FIG. 9b) suggests the presence of a stabilizing interaction, hindering crystallization of the amorphous steviol glycosides. Only the thermogram of the homogenized inclusion complex of rebaudioside D and gamma cyclodextrin (FIG. 9c) displays a non-negligible peak at the expected melting temperature suggesting that homogenization breaks up the stabilizing interactions of the inclusion complex.

Additionally, above approximately 260 C, the thermogram of FIG. 8b appears smooth until decomposition is reached. In contrast, the thermogram of FIG. 8c displays a weak endothermic event at 278 C, which coincides with the melting temperature of rebaudioside D. Without wishing to be bound by any particular theory, the result suggests some small amount of crystalline steviol glycoside may be present in the homogenized inclusion complex of rebaudioside D and gamma cyclodextrin (FIG. 8c). Without wishing to be bound by any particular theory, the absence of the endotherm for FIG. 8b is the expected result for an inclusion complex, in which crystallization and subsequent melting are precluded by the stabilizing interaction.

### Example 5

### IR Data

Terpene glycosides, cyclodextrin, and various complexes and physical mixtures were analyzed by infrared (IR) spectroscopy. IR spectra were acquired on Magna-IR 860® Fourier transform infrared (FT-IR) spectrophotometer (Thermo Nicolet) equipped with an Ever-Glo mid/far IR source, an extended range potassium bromide (KBr) beamsplitter, and a deuterated triglycine sulfate (DTGS) detector. Wavelength verification was performed using NIST SRM 1921b (polystyrene). An attenuated total reflectance (ATR) accessory (Thunderdome™, Thermo Spectra-Tech), with a germanium (Ge) crystal was used for data acquisition. Each spectrum represents 256 co-added scans collected at a spectral resolution of 4 cm⁻¹. A background data set was acquired with a clean Ge crystal. A Log 1/R (R=reflectance) spectrum was obtained by taking a ratio of these two data sets against each other.

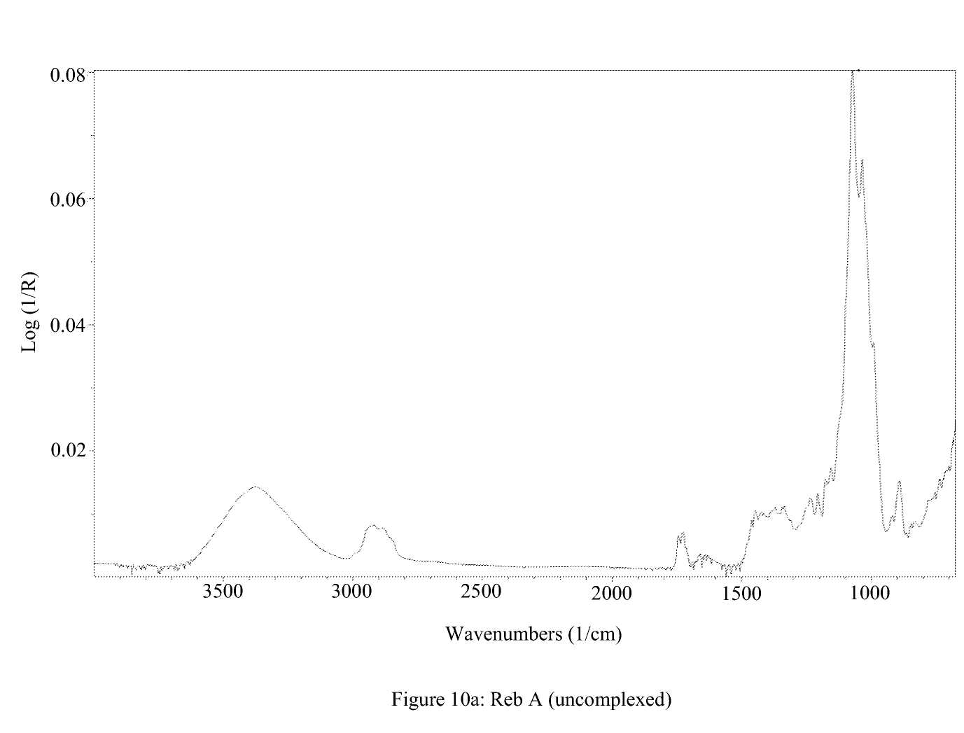

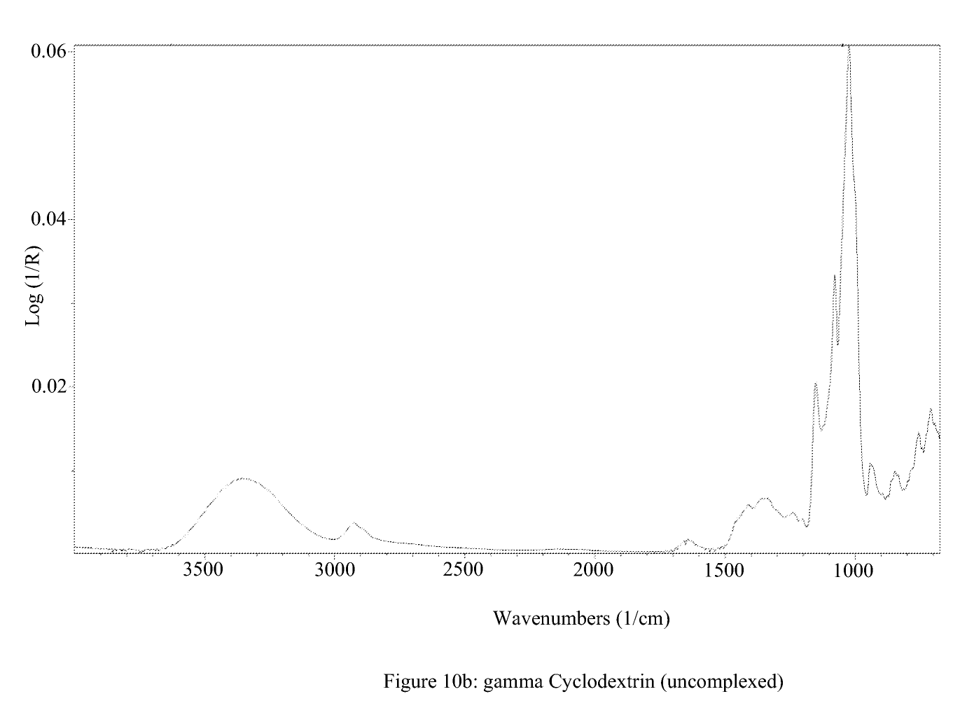

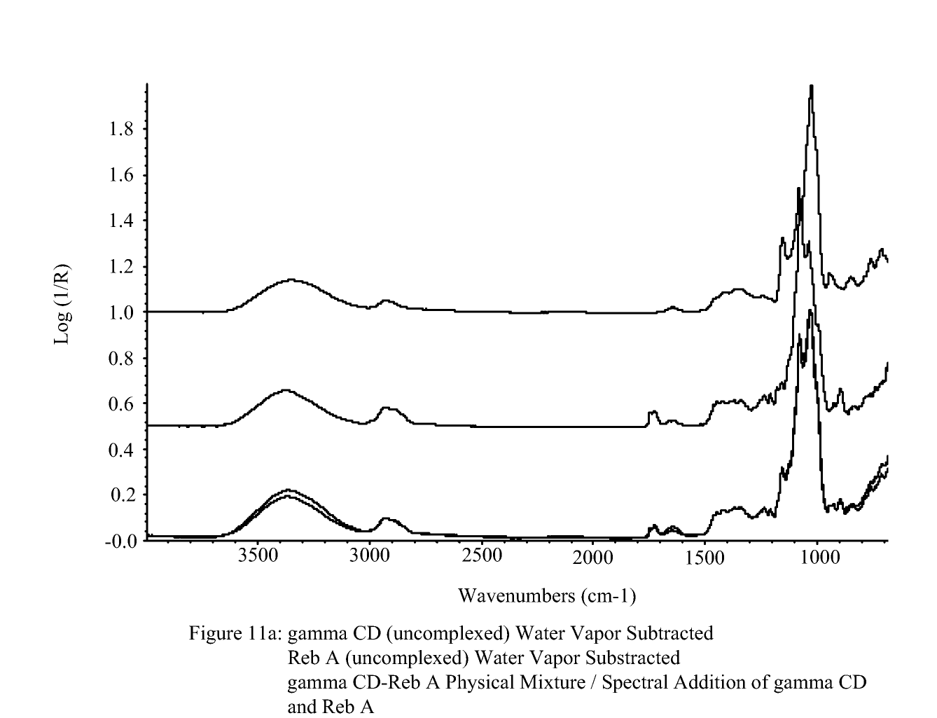

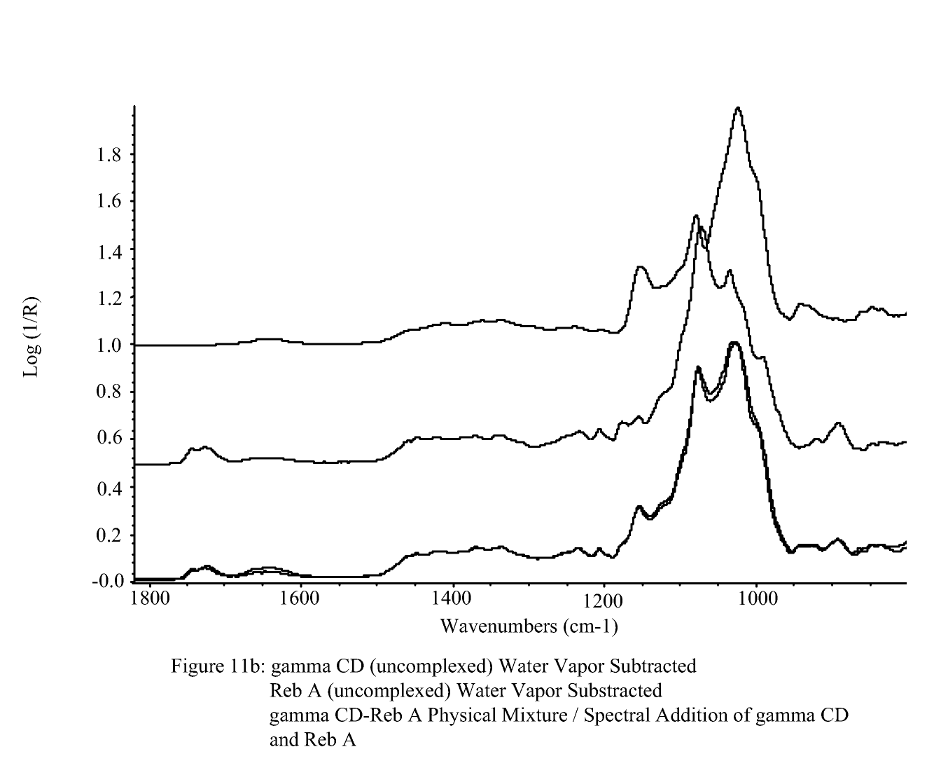

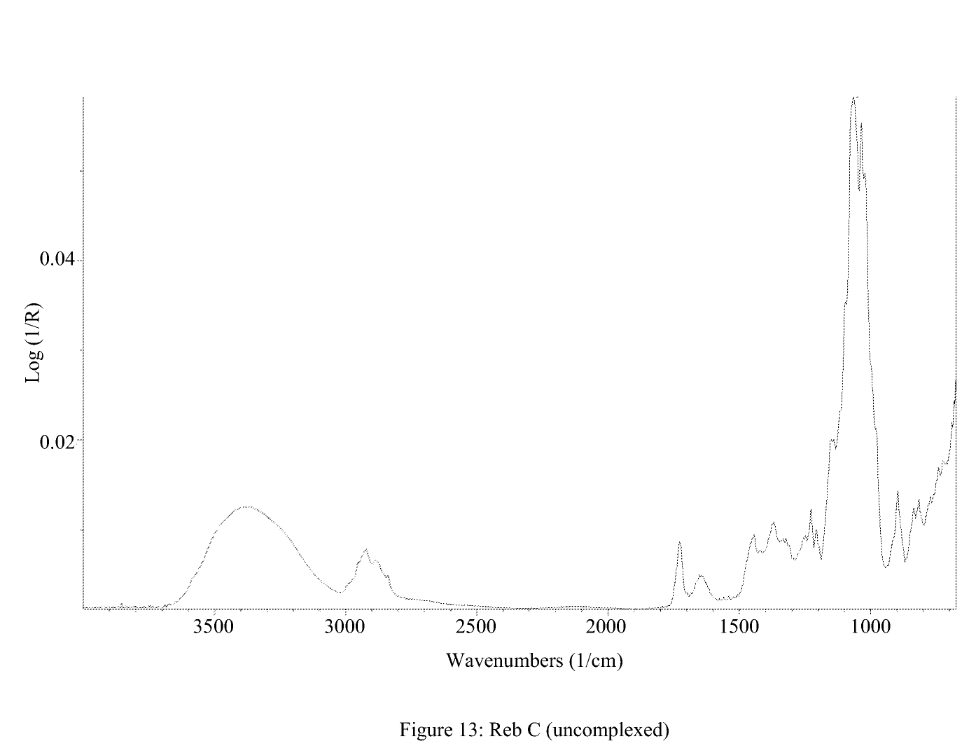

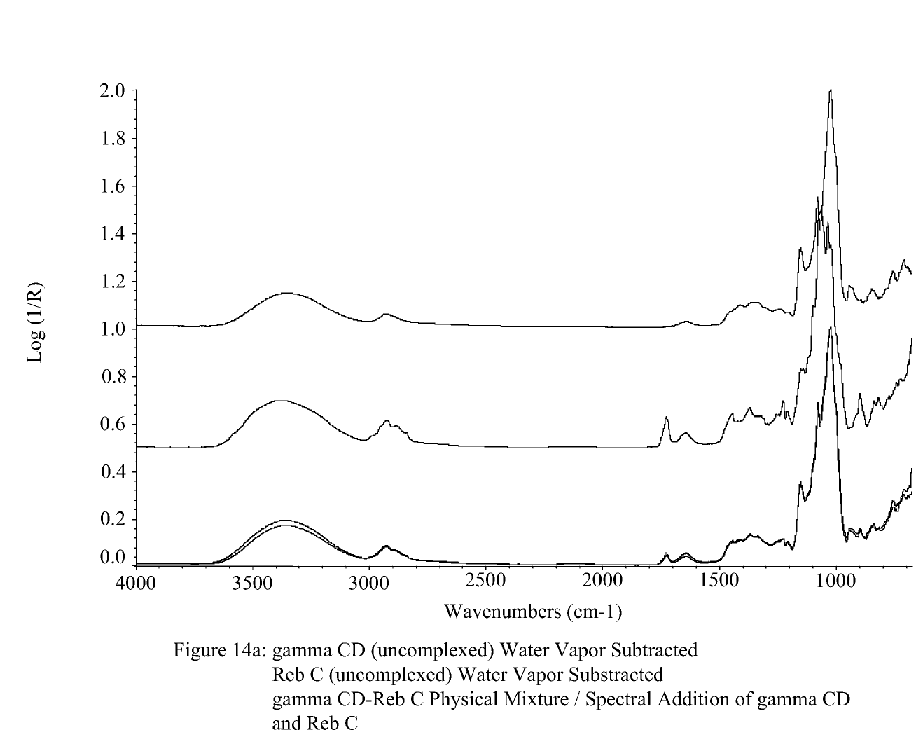

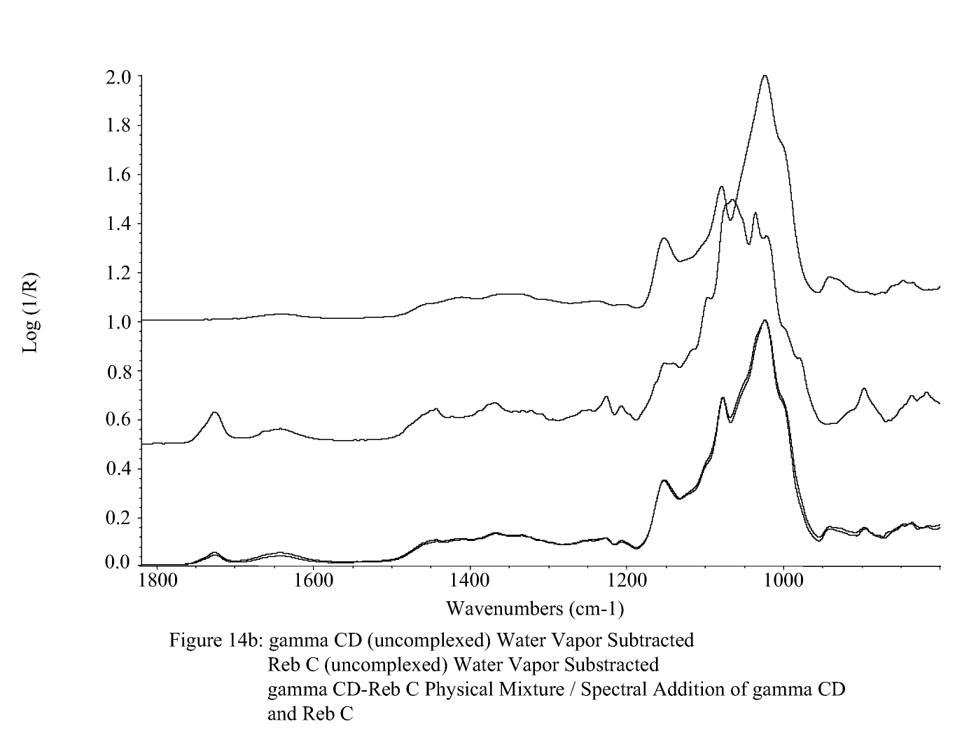

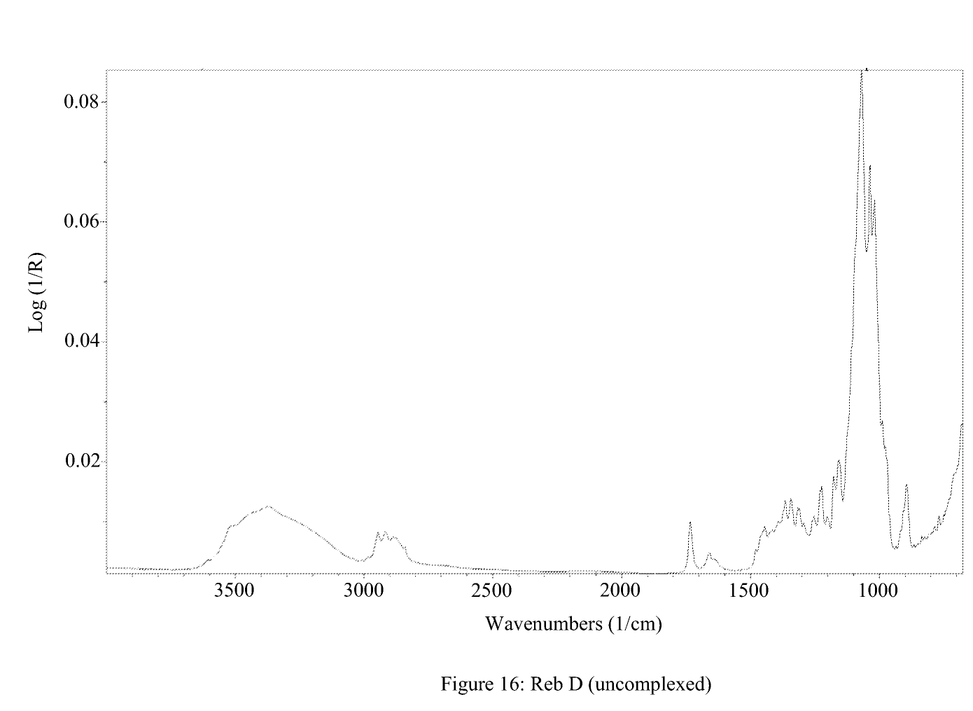

Spectra of uncomplexed reb A, cyclodextrin, reb C, and reb D are found at FIGS. 10a, 10b, 13, and 16, respectively. The infrared spectra of cyclodextrin and the steviol glycosides were corrected for presence of water vapor and intensity normalized. Spectral combinations of IR spectra (FIGS. 11a, 11b, 14a, 14b, 17a, and 17b) were generated using cyclodextrin and each steviol glycoside; each component spectrum was arbitrarily scaled to produce an addition spectrum that closely resembles the corresponding physical mixture spectrum. These addition spectra are overlaid with the infrared spectra of the corresponding supplied physical mixtures (appearing as the bottom traces in each plot). Infrared spectra of cyclodextrin and each steviol glycoside appear as the upper traces in the plots. The calculated addition spectra match well to the physical mixture spectra.

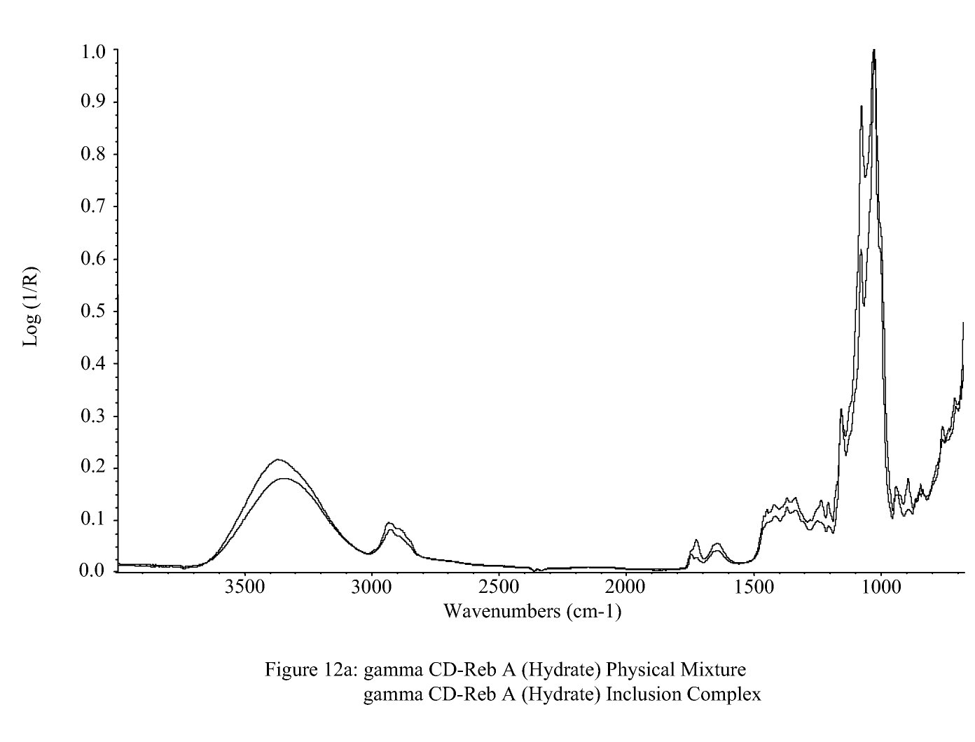

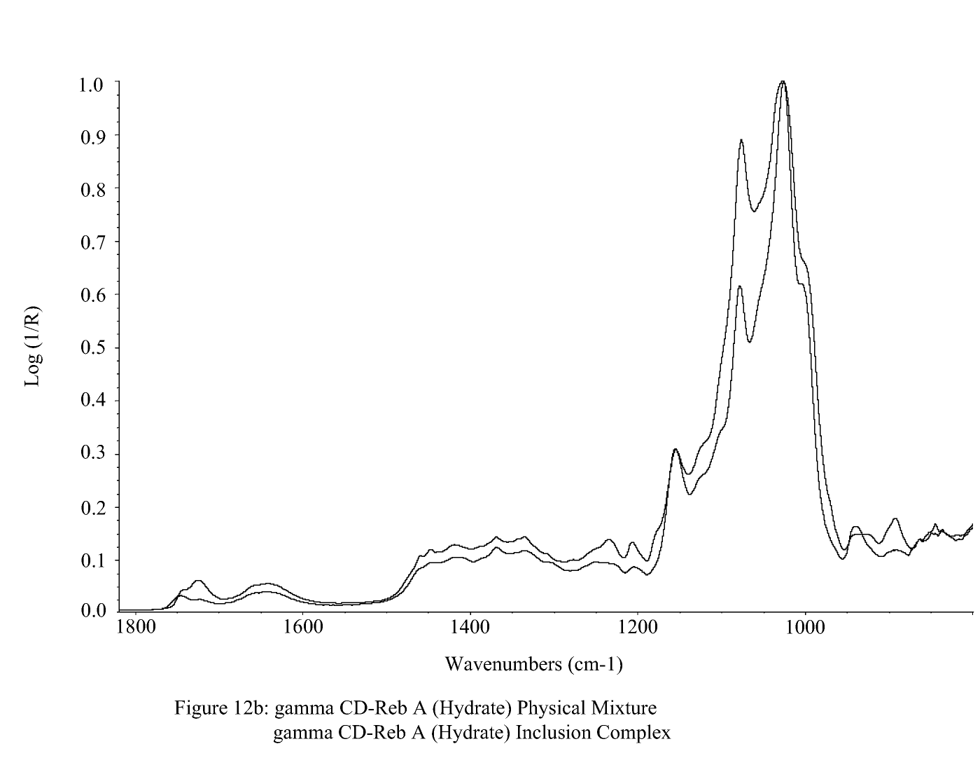

FIGS. 12a, 15a, and 18a display overlays of the intensity normalized infrared spectra of each inclusion complex with its corresponding physical mixture. FIGS. 12b, 15b, and 18b provide an expanded view of the spectra in the approximate region 1800-800 cm⁻¹. Infrared spectra of the inclusion complexes and corresponding physical mixtures display clear variations in band positions and intensities, indicating differences in solid state compositions of each sample set. Selected examples are described below.

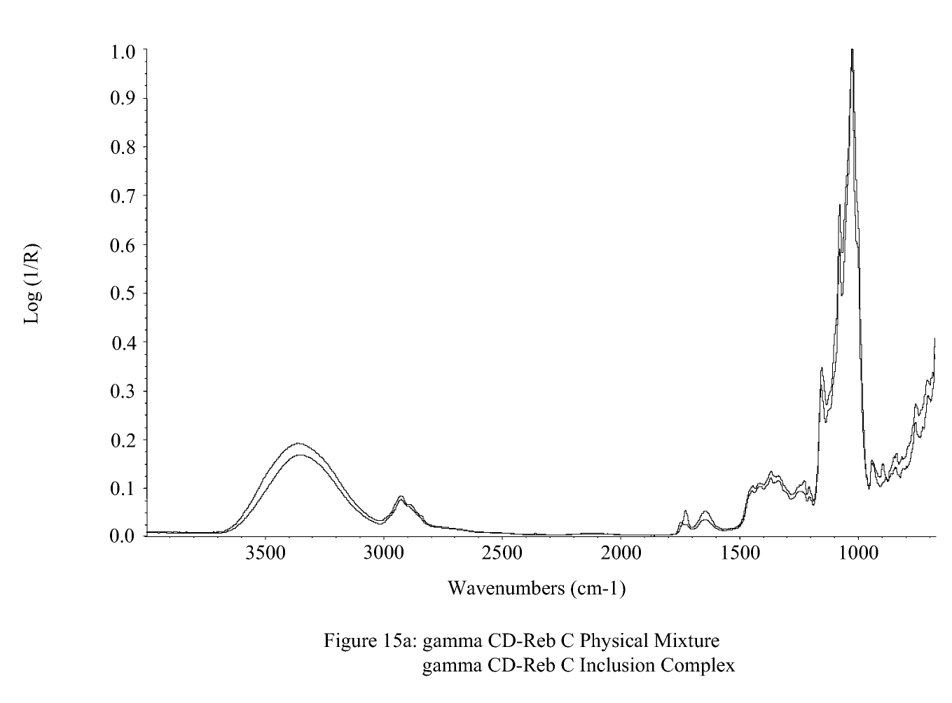

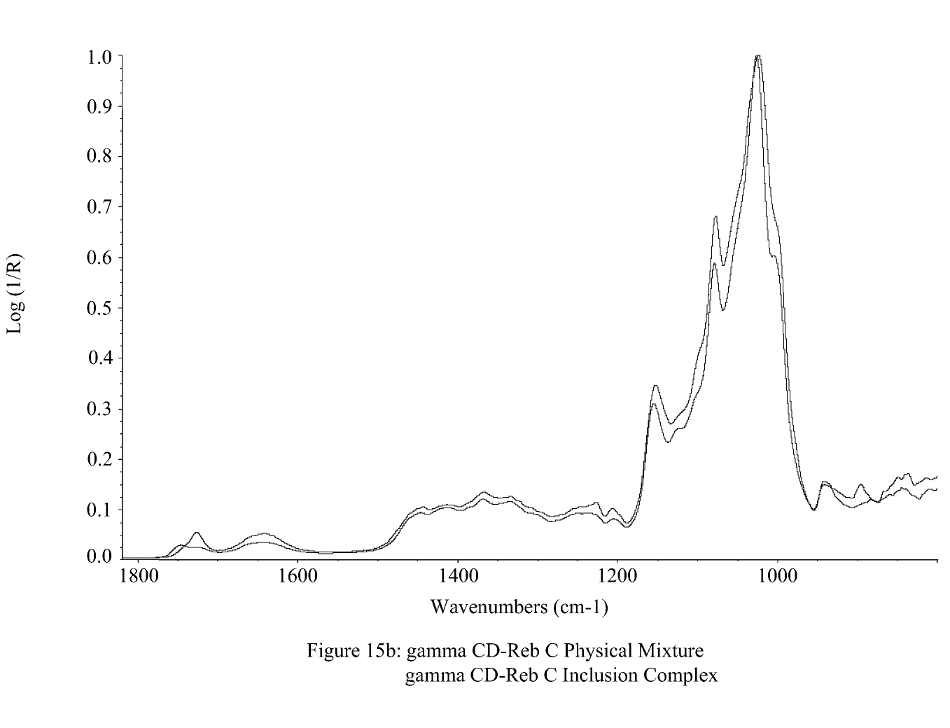

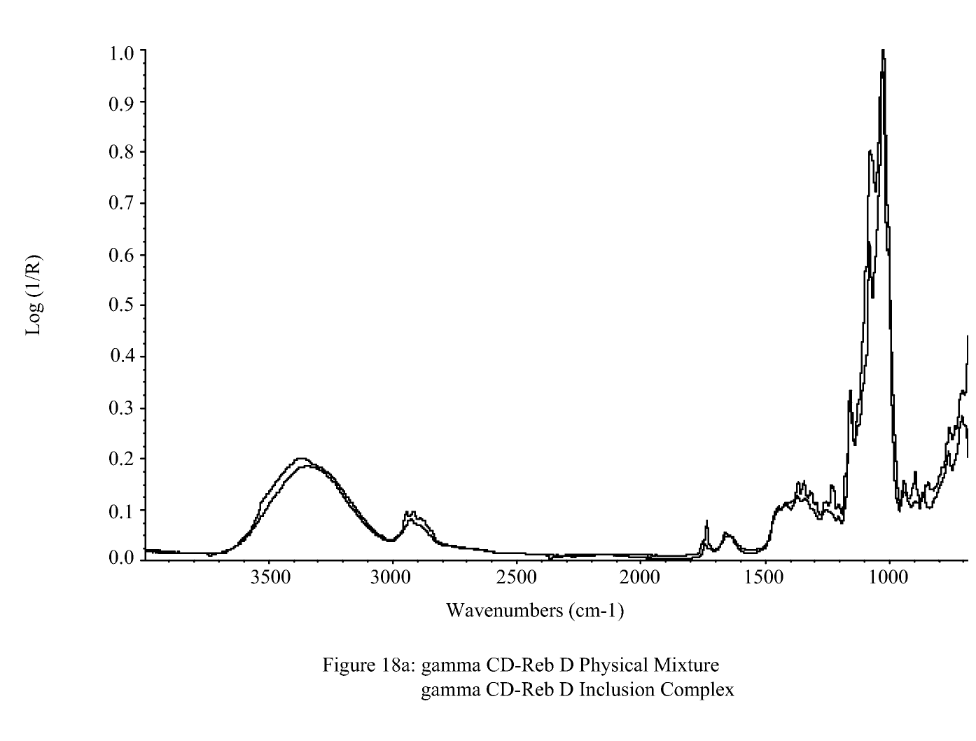

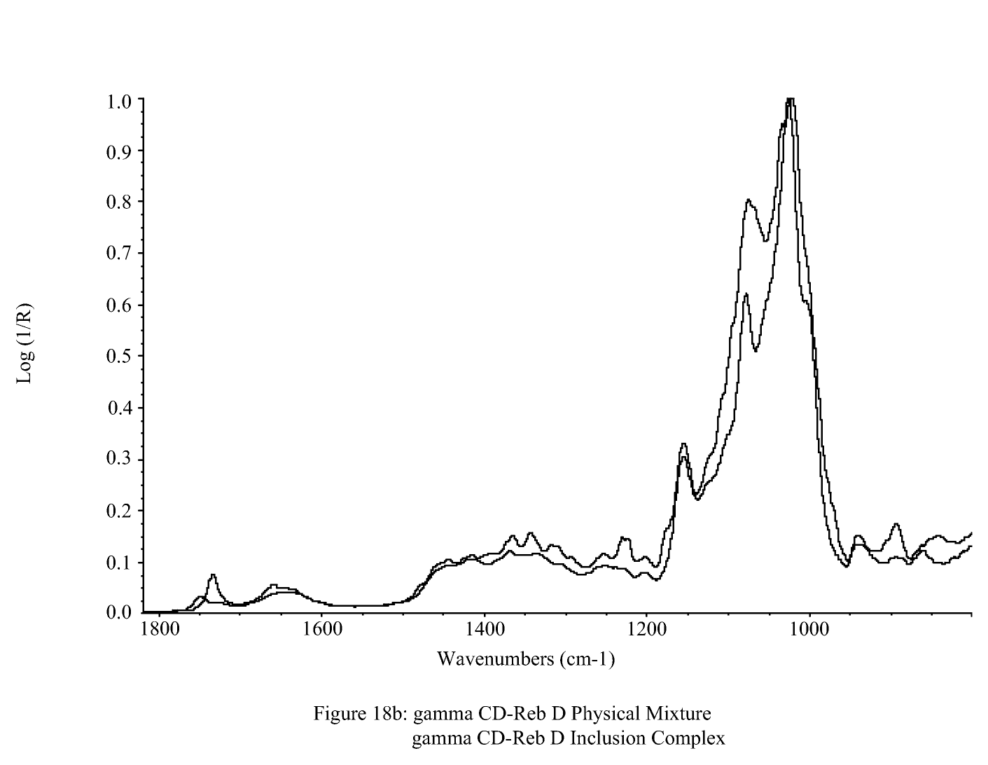

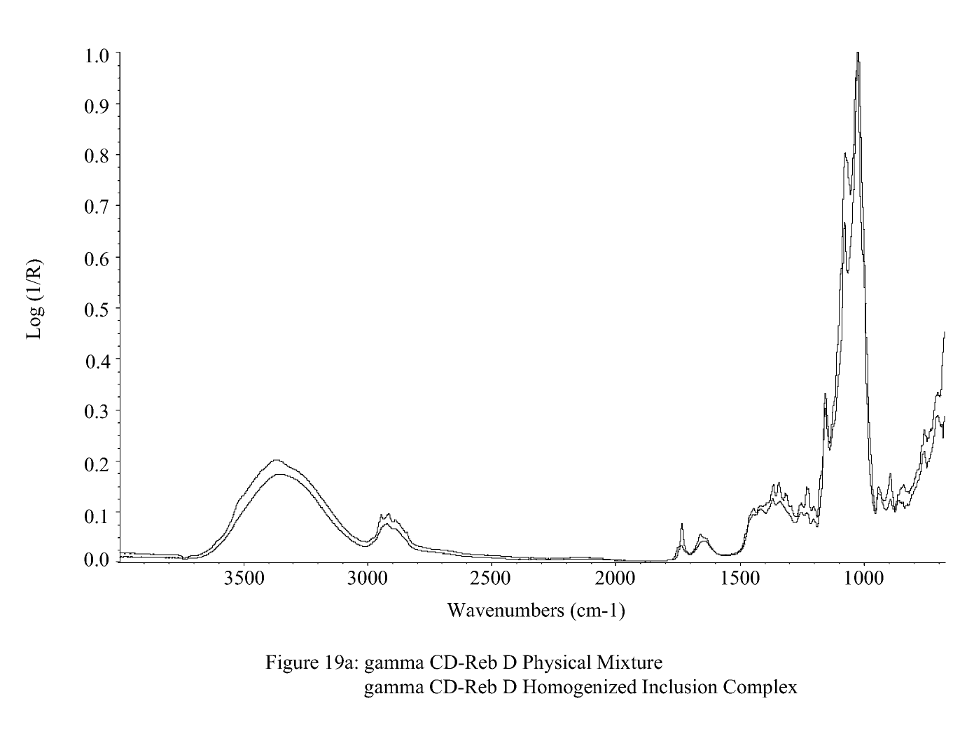

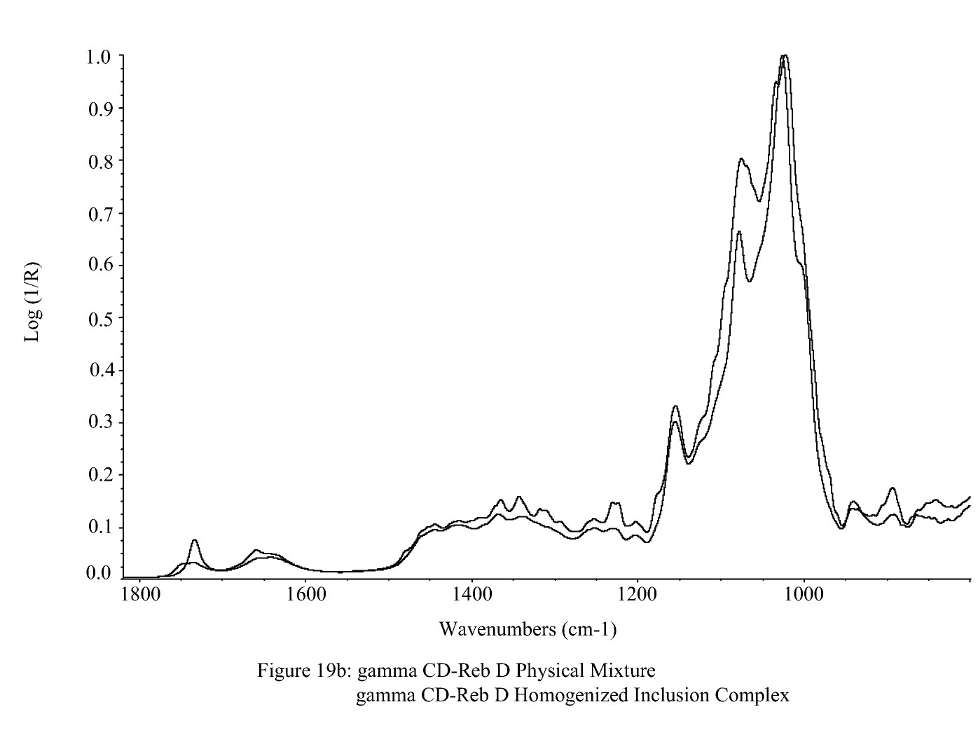

Spectra for inclusion complexes (FIGS. 12a, 12b, 15a, 15b, 18a, 18b, 19a, and 19b) display the steviol glycoside carbonyl band near 1750 cm⁻¹ with greater relative intensity than a weaker shoulder band near 1730 cm⁻¹. In contrast, spectra of physical mixtures of gamma cyclodextrin with rebaudioside C and D (FIGS. 15a, 15b, 18a, and 18b) display only a single band near 1730 cm⁻¹; spectra of the physical mixture of rebaudioside A with gamma cyclodextrin (FIGS. 12a, and 12b) display both bands in the carbonyl region, but the 1750 cm⁻¹ band appears as a shoulder to the more intense 1730 cm⁻¹ band.

Distinctive spectral features assigned to cyclodextrin vibrational modes are noted in the data. For example, in the spectra of cyclodextrin and the physical mixtures samples, the strongest C—O stretching band is present at 1026 cm⁻¹; however, the band is shifted to 1023 cm⁻¹ in the spectra of the inclusion complexes. Similarly, the weak band at 1150 cm⁻¹ in the spectra of cyclodextrin and the physical mixtures samples is shifted to 1155 cm⁻¹ in the spectra of the inclusion complexes.

Other notable differences in the spectra of the inclusion complexes (FIGS. 12a, 12b, 15a, 15b, 18a, and 18b) and corresponding physical mixtures (FIGS. 11a, 11b, 14a, 14b, 17a, and 17b) include the markedly reduced intensity of the 1080 cm-¹ band in the spectra of the inclusion complexes, and differences in shape and relative intensities for both the broad band in the hydroxyl stretching region and the series of bands in the CH stretching region.

Without wishing to be bound to a particular theory, the observation of shifted bands and anomalous intensities in the spectra of the inclusion complexes is consistent with the anticipated presence of an interaction between cyclodextrin and the steviol glycosides. Note that the amorphous/crystalline character of the steviol glycosides was not determined at the time of analyses, and thermal events were observed in the DSC data that allow for the possibility that some crystallization may have occurred for the amorphous samples, complicating interpretation of the spectroscopic data. However, the observation of band shifting for vibrations assigned to cyclodextrin (cyclodextrin was determined to be amorphous by XRPD (FIG. 1)) further supports the hypothesis of a stabilizing interaction present in the inclusion complexes.

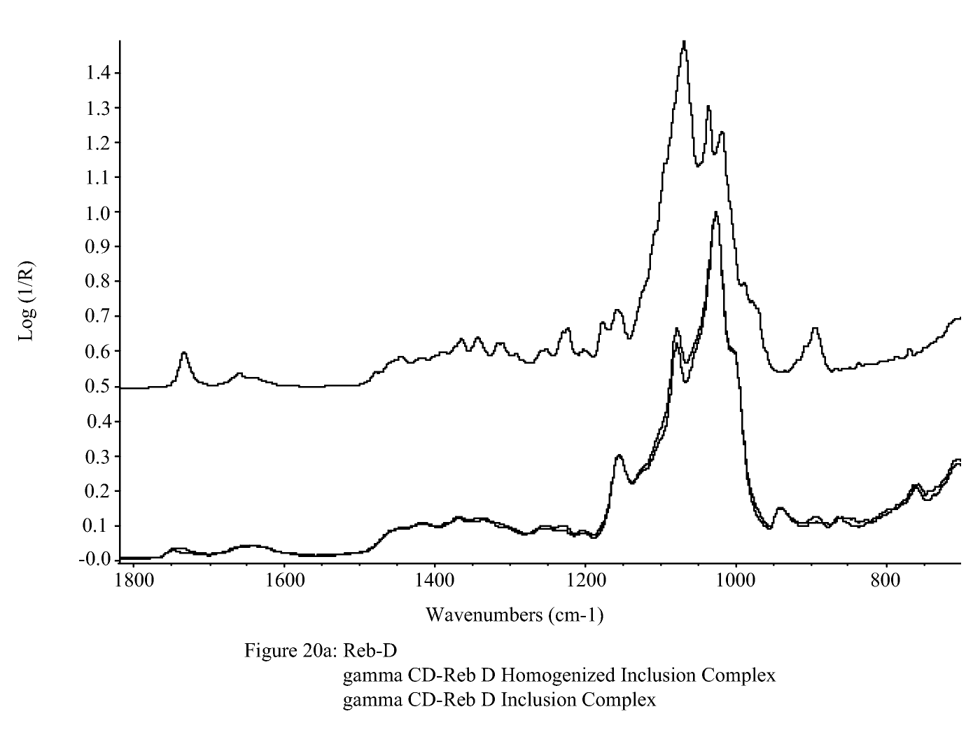

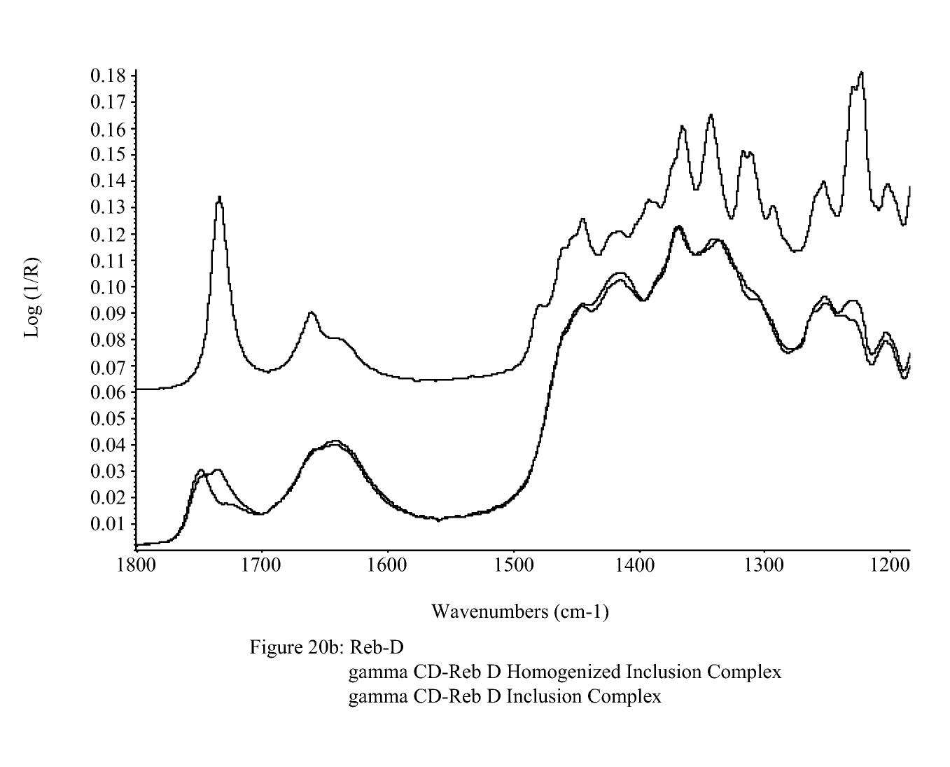

Differences in band intensities are evident in various regions of the spectra for the homogenized inclusion complex of gamma cyclodextrine and rebaudioside D, as compared to gamma cyclodextrin-redbaudioside D inclusion complex (FIG. 20a and FIG. 20b). The spectral regions displaying intensity differences correspond to band frequencies in the spectrum of rebaudioside D (top trace), suggesting the presence of a phase impurity of this steviol glycoside in the sample. DSC data for the homogenized inclusion complex also indicated evidence of a possible phase impurity (weak endotherm present at melting temperature). Without wishing to be bound by any particular theory, this impurity appears to be some steviol glycoside free from an inclusion complex as a result of the homogenization.

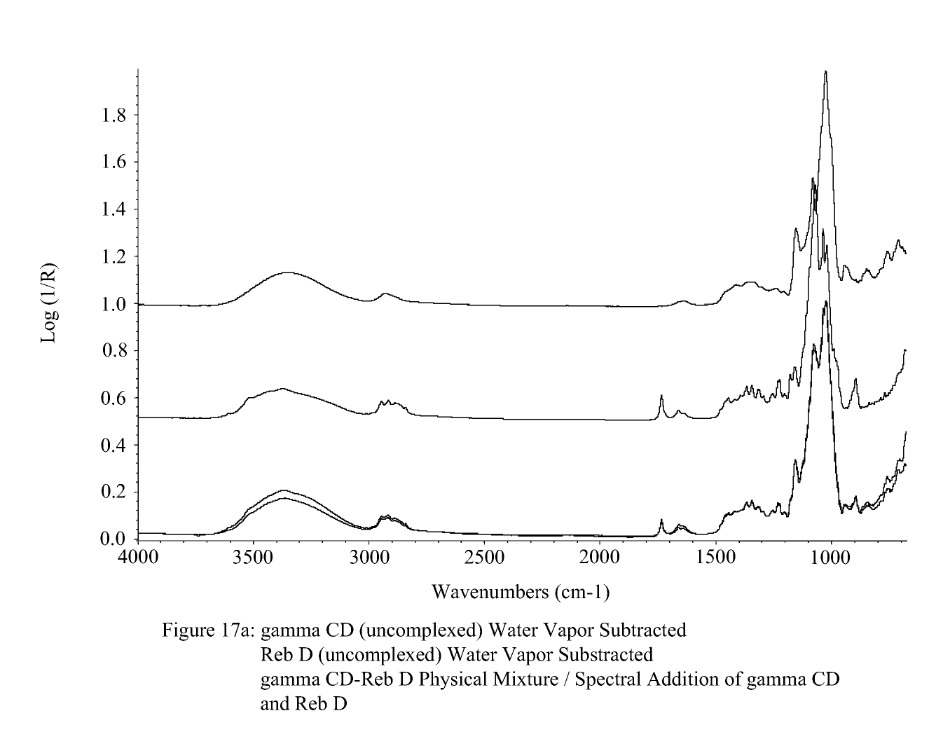

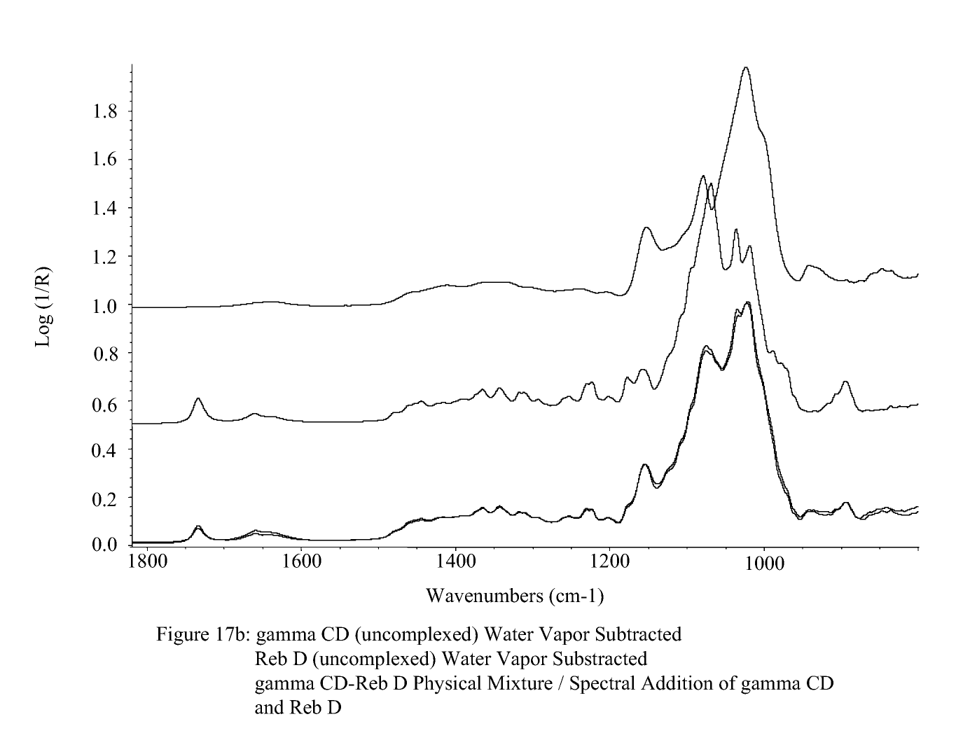

Additionally, in the region 1750-1730 cm-1 of FIG. 20b, the spectrum of the rebaudioside D inclusion complex displays a peak at 1750 cm-1 with a weaker shoulder near 1730 cm-1. In contrast, the spectrum of the homogenized rebaudioside D inclusion complex displays peaks of similar intensity at both noted frequencies, with the peak at 1730 cm-1 being slightly stronger. The peak at 1750 cm-1 is unique to the inclusion complexes. The 1730 cm-1 peak coincides with a band in the spectrum of rebaudioside D uncomplexed and rebaudioside D gama-CD physical mixture (FIG. 17b).

Similarly, the peak near 1230 cm-1 in the spectra of the inclusion complexes appears with slightly stronger intensity in the spectrum of the rebaudioside D inclusion complex relative to the homogenized rebaduiside D inclusion complex. This peak at 1230 cm-1 also coincides with a band in the spectrum of the corresponding steviol glycoside and physical mixture. Without wishing to be bound by any particular theory, the results suggest the homogenized rebaudioside D inclusion complex is composed of a mixture of phases. The regions of spectral difference between rebaudioside D inclusion complex and homogenized rebaudioside D inclusion complex coincide with the steviol glycoside component of the sample.

### Example 6

### Raman Data

Terpene glycosides, cyclodextrin, and various complexes and physical mixtures were analyzed by Raman spectroscopy. Raman spectra were acquired on a FT-Raman module interfaced to a Nexus 670 FT-IR spectrophotometer (Thermo Nicolet) equipped with an indium gallium arsenide (InGaAs) detector. Wavelength verification was performed using sulfur and cyclohexane. Each sample was prepared for analysis by placing the sample into a pellet holder. Approximately 0.5 W of Nd:YVO₄ laser power (1064 nm excitation wavelength) was used to irradiate the sample. Each spectrum represents either 256 or 512 co-added scans collected at a spectral resolution of 4 cm⁻¹.

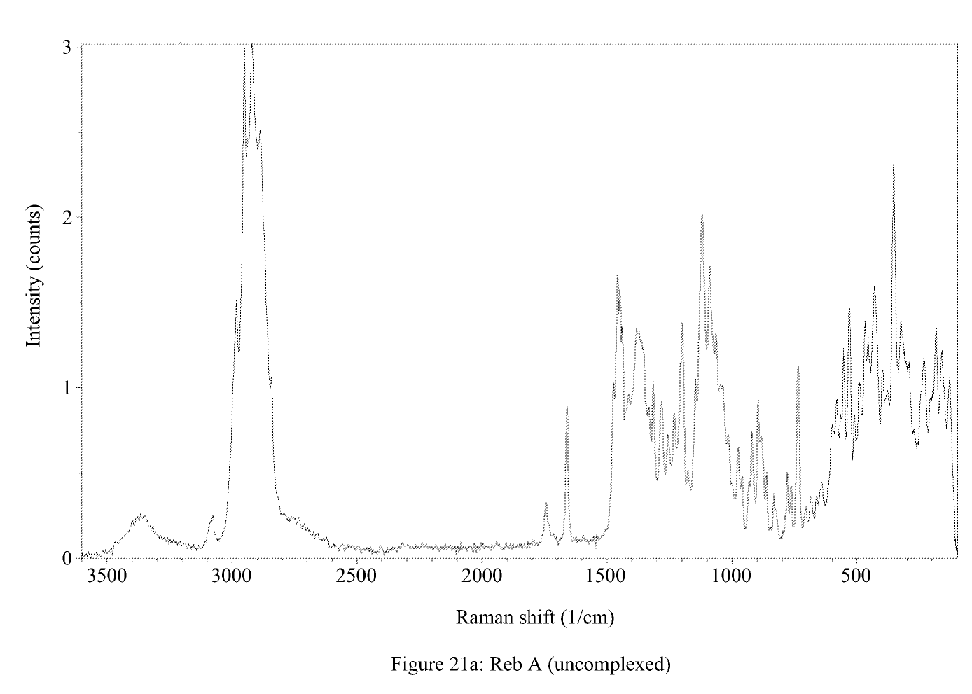

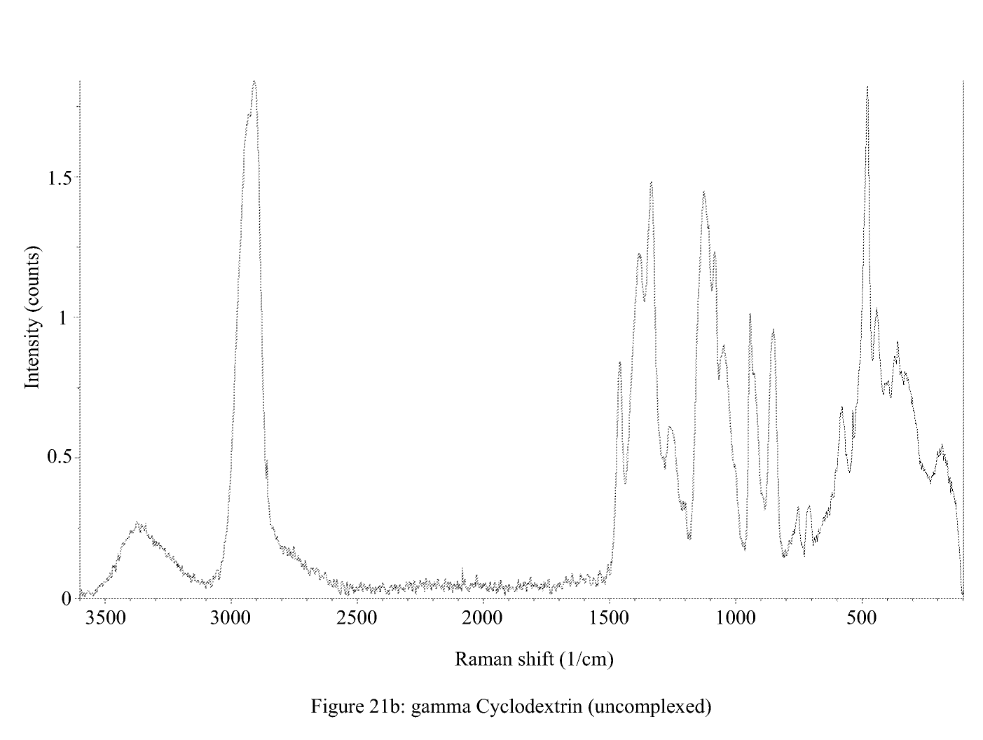

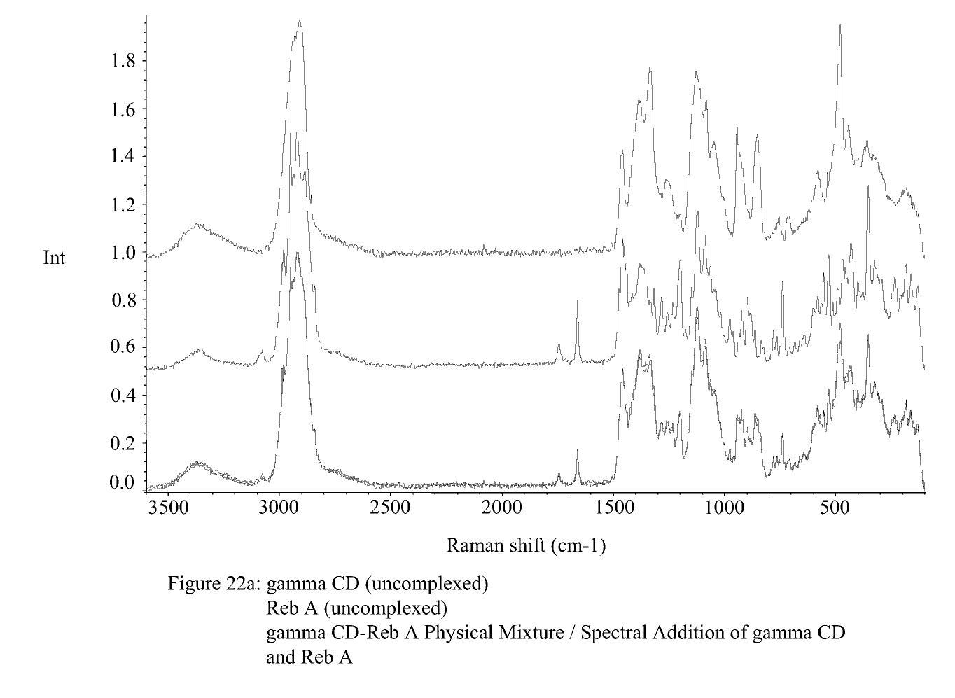

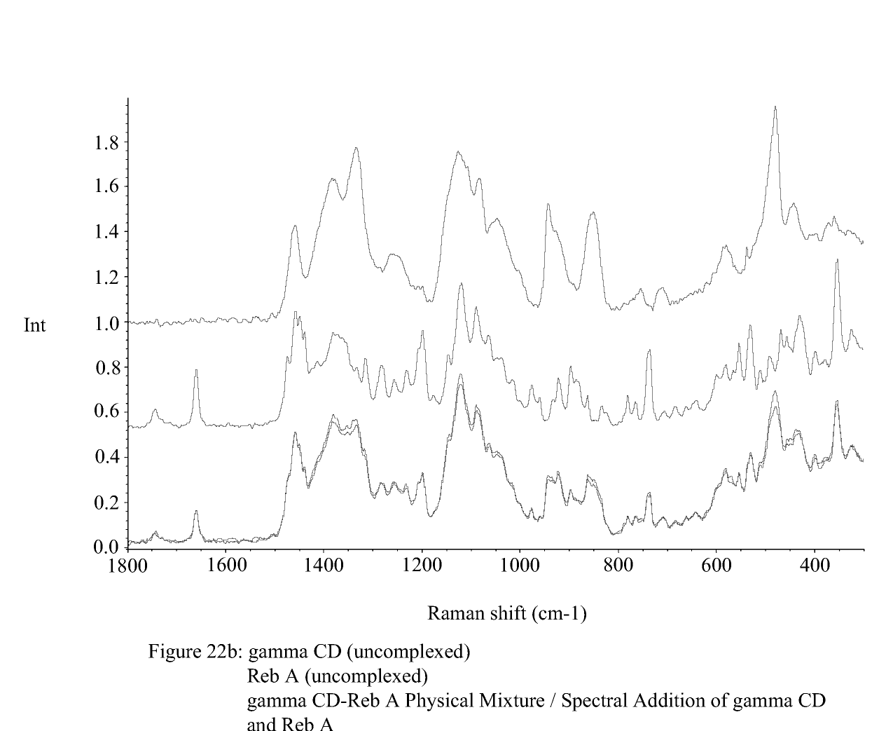

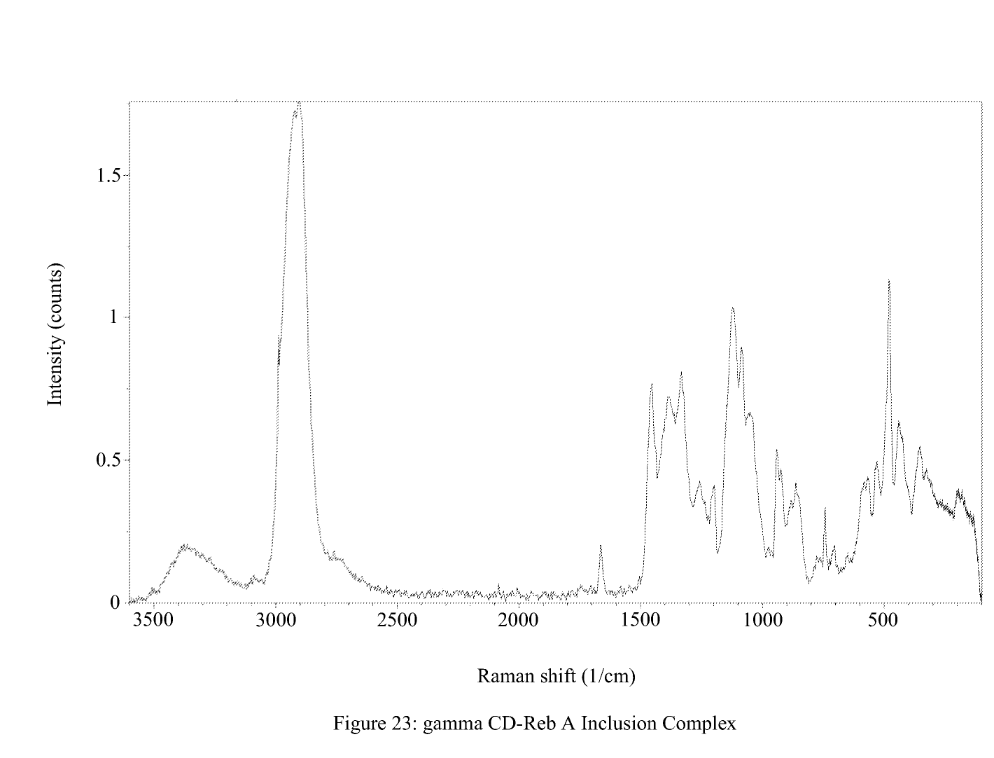

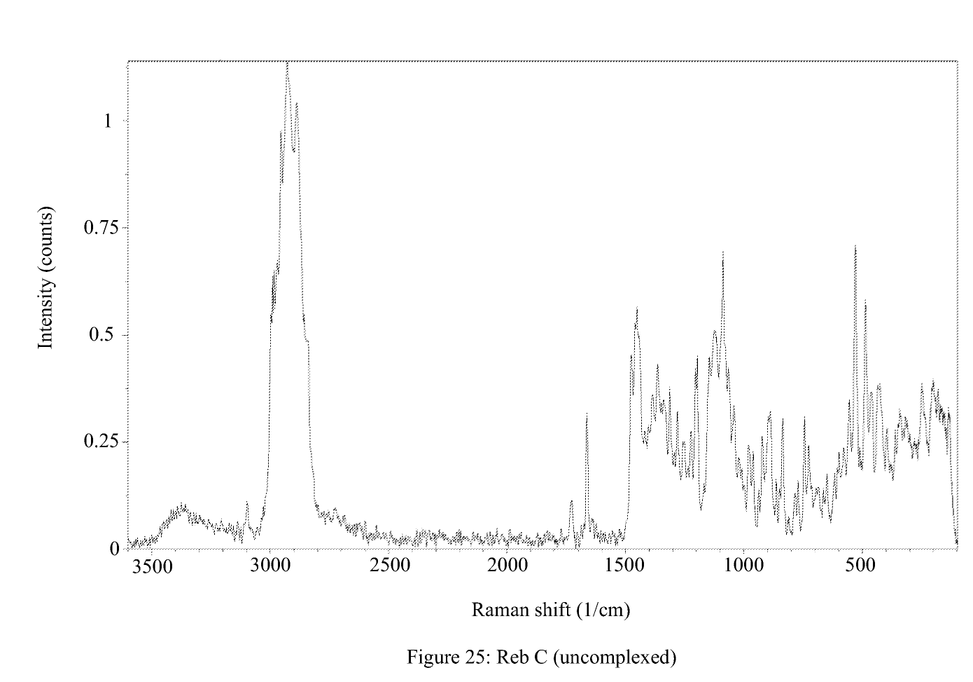

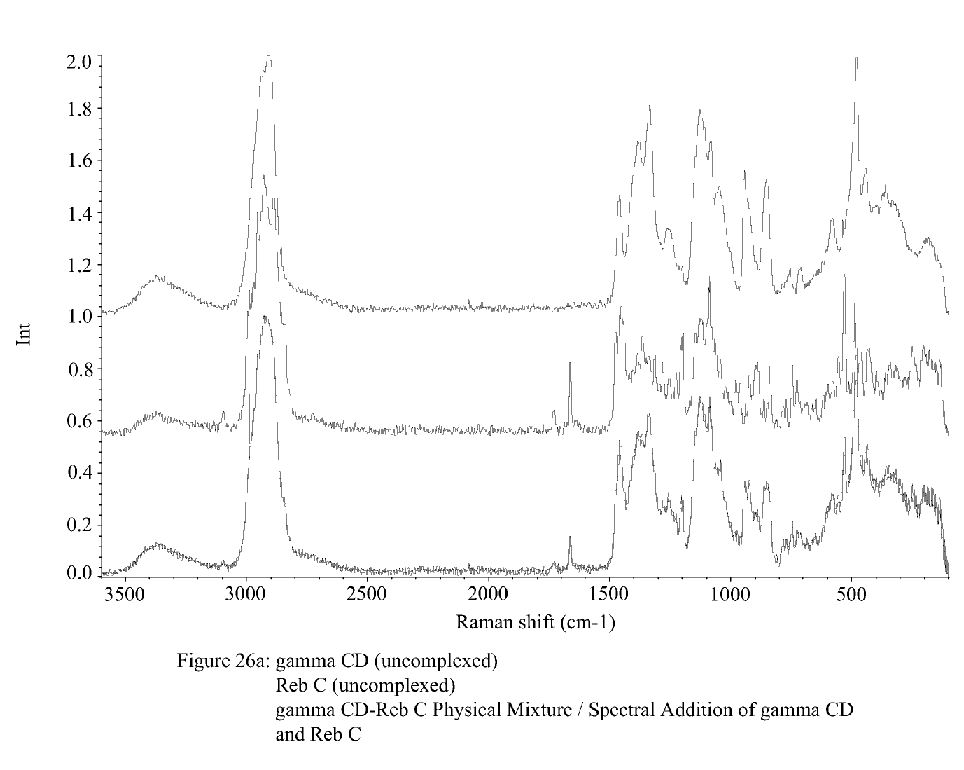

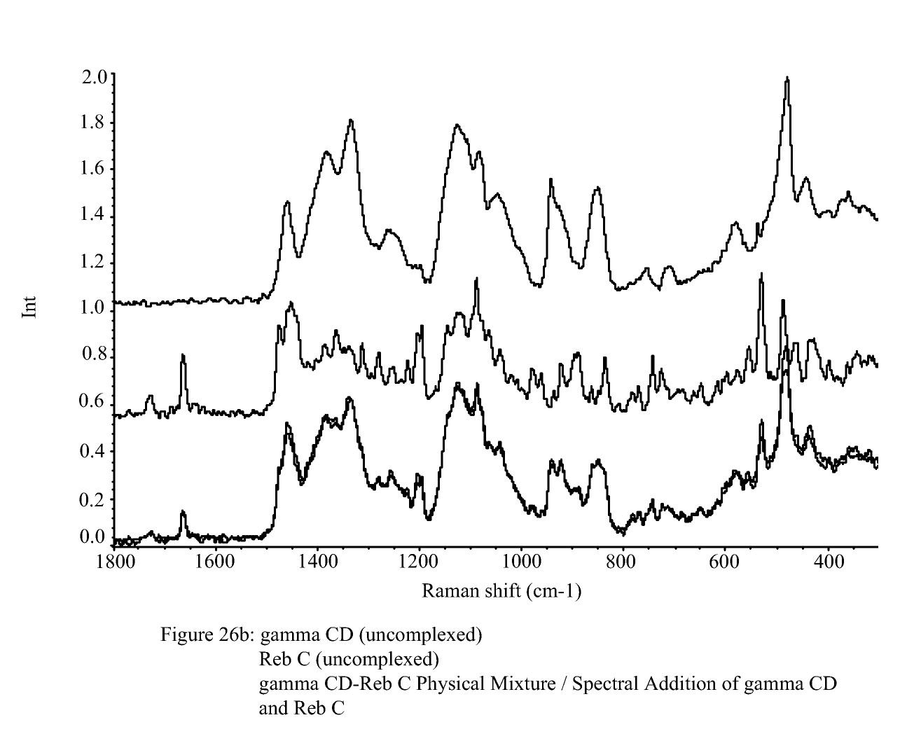

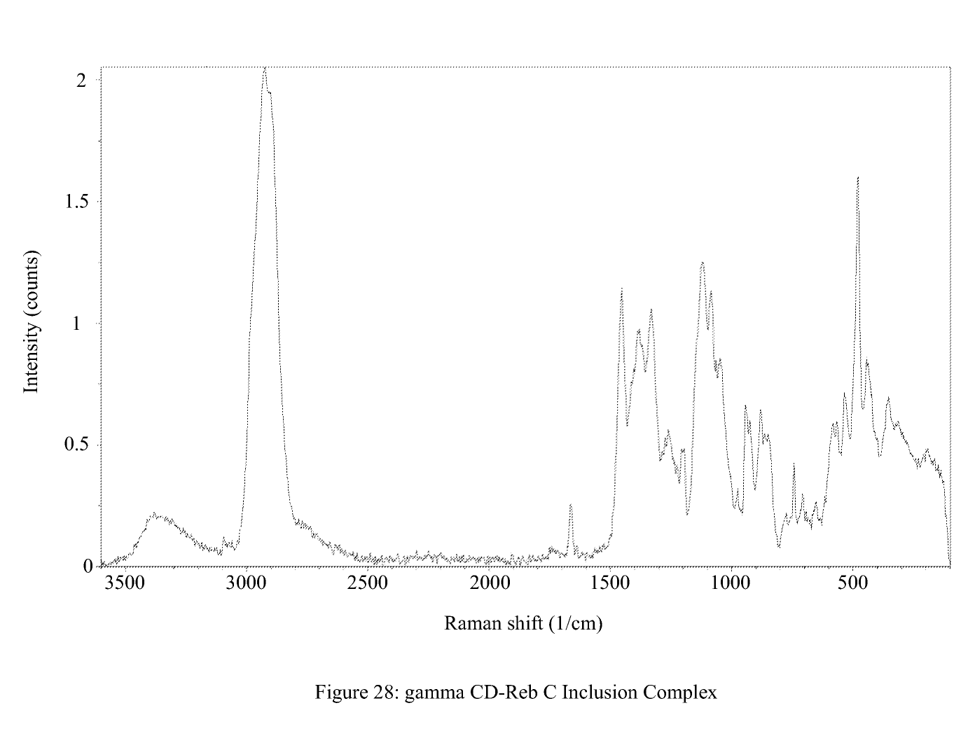

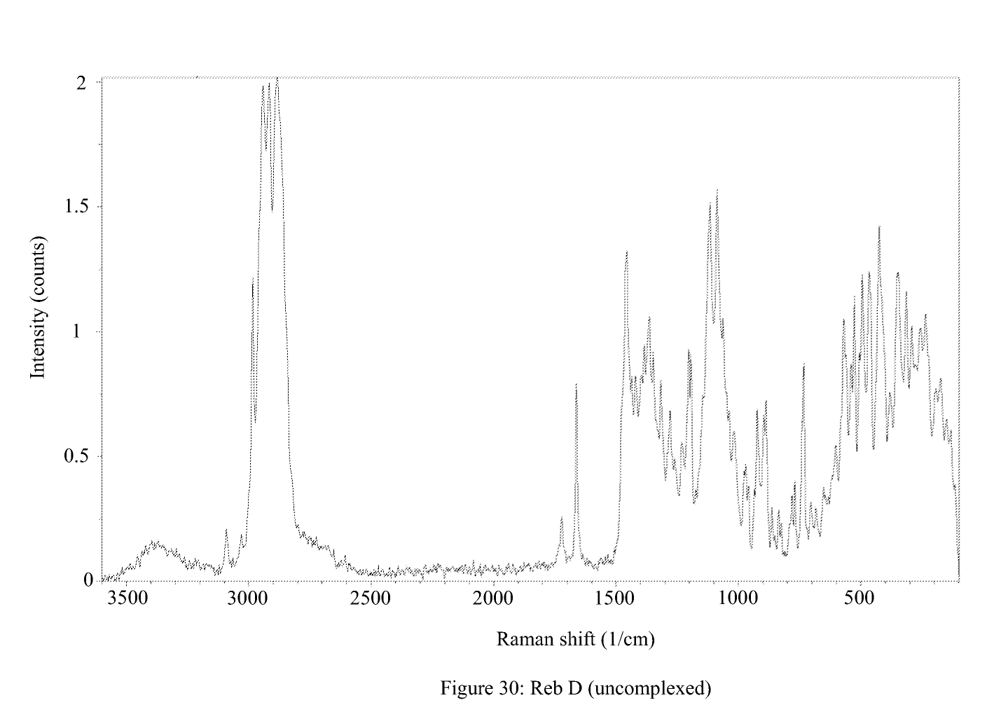

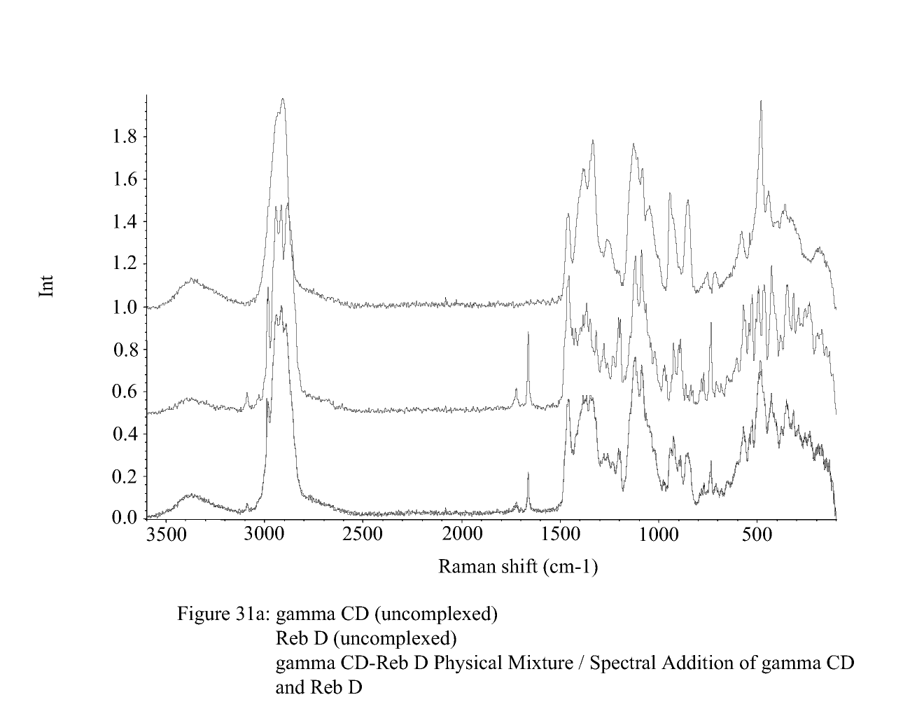

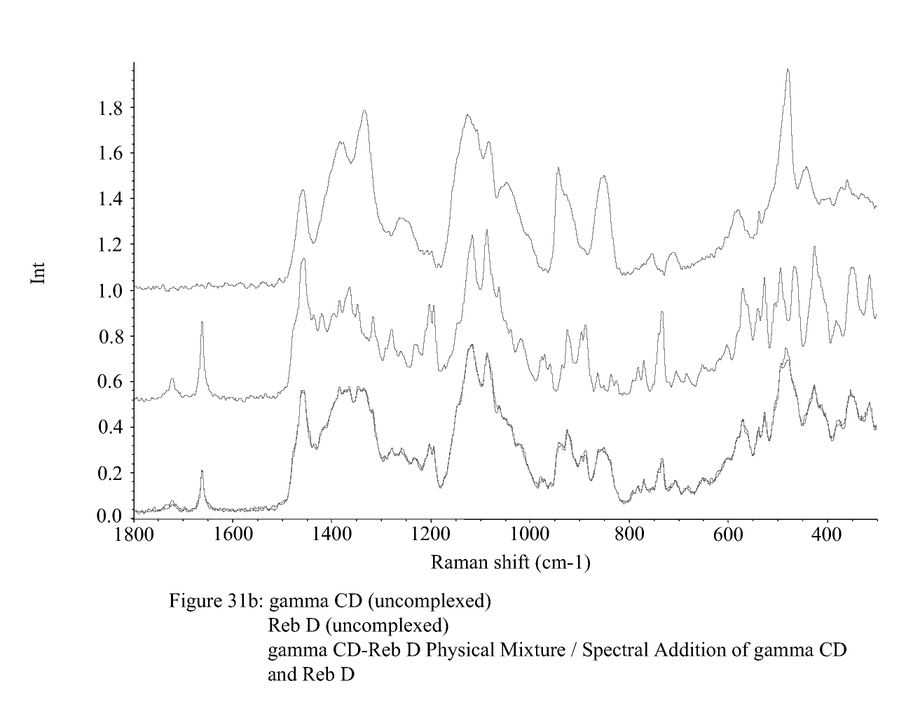

Raman spectra were treated similar to the infrared data. Spectra of uncomplexed reb A, cyclodextrin, reb C, and reb D are found at FIGS. 21a, 21b, 25, and 30, respectively. Spectra of the various complexes can be found at FIGS. 23 and 28. Overlays of the Raman addition spectra and the corresponding physical mixture data are displayed in FIGS. 22a, 22b, 26a, 26b, 31a, and 31b. The calculated addition spectra match well to the physical mixture spectra.

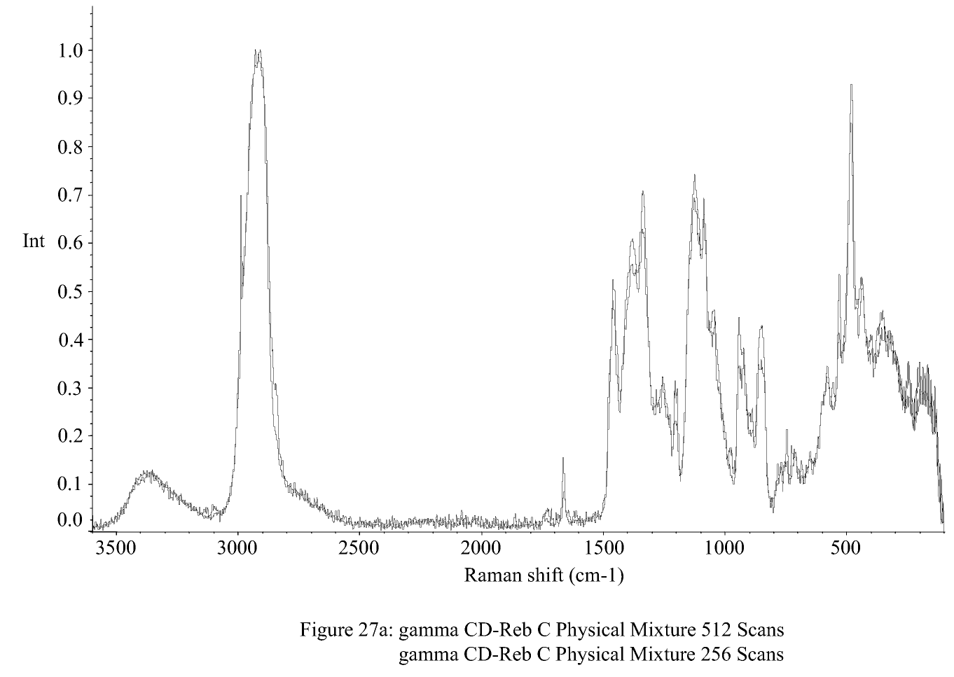

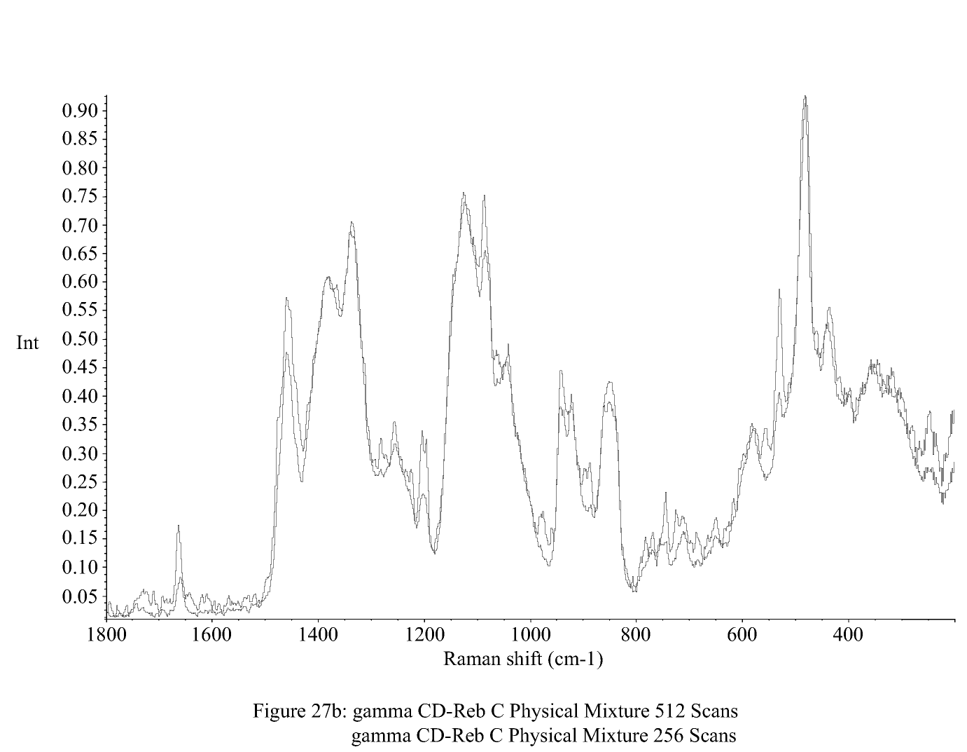

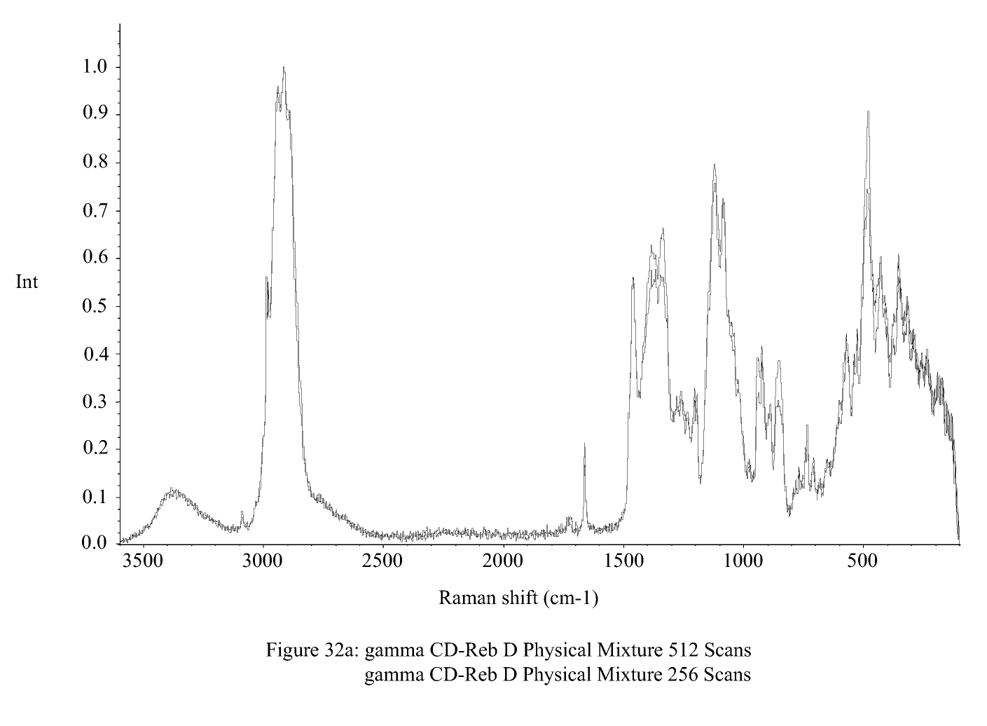

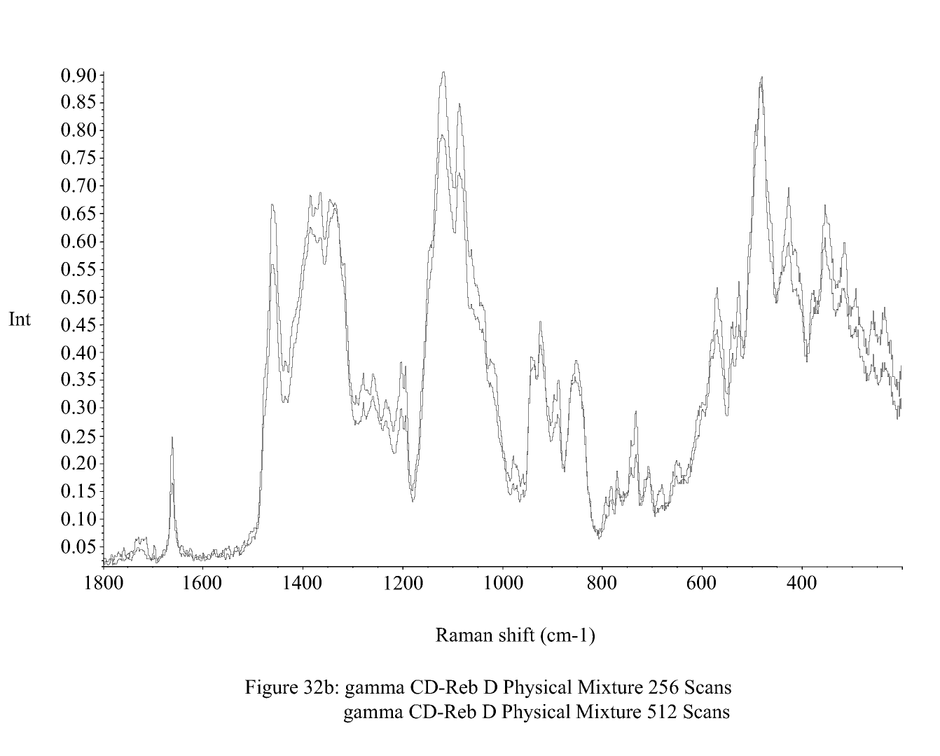

Raman spectra of the physical mixture and inclusion complex samples were captured after both 256 and 512 scans during data acquisition, to investigate the effect of the Raman laser on the integrity of the samples. Only minor differences were observed between the two spectra for each sample, with the exception of rebaudioside C physical mixture (FIGS. 27a and 27b) and rebaudioside D physical mixture (FIGS. 32a and 32b). The figures display Raman spectra acquired after both 256 and 512 spectral acquisitions. Evaluation of Raman data was carried out using the spectra acquired after 256 accumulations for all samples.

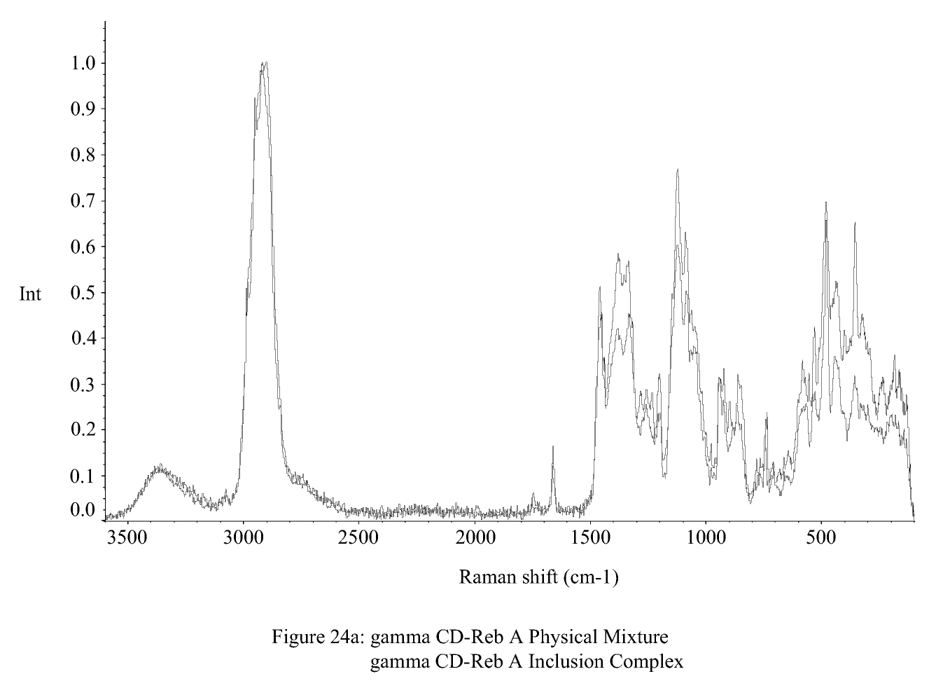

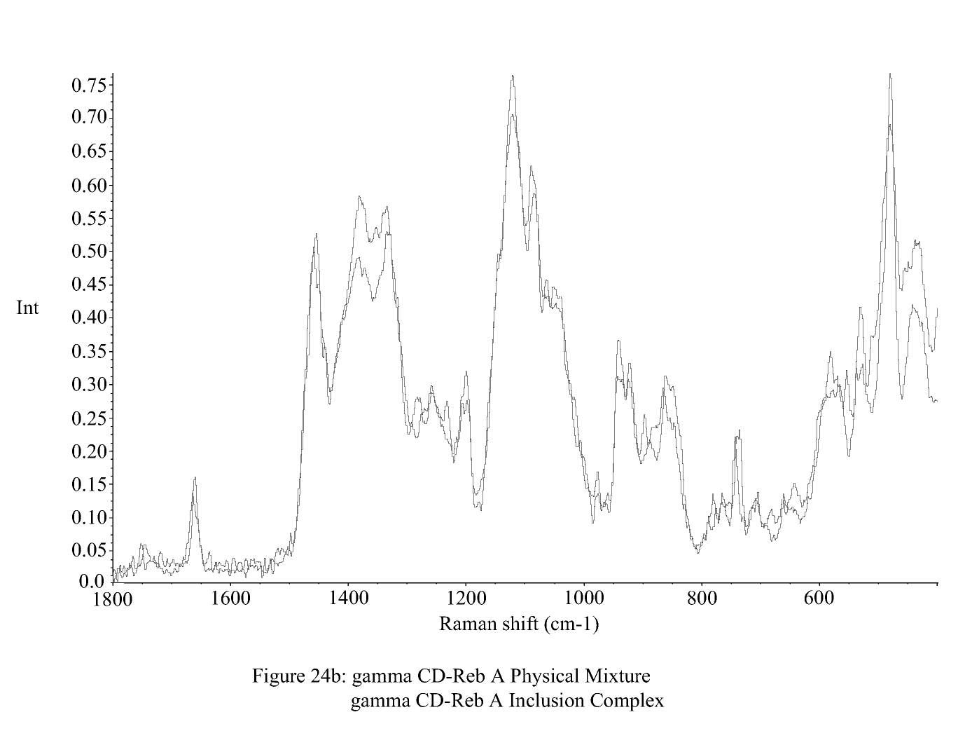

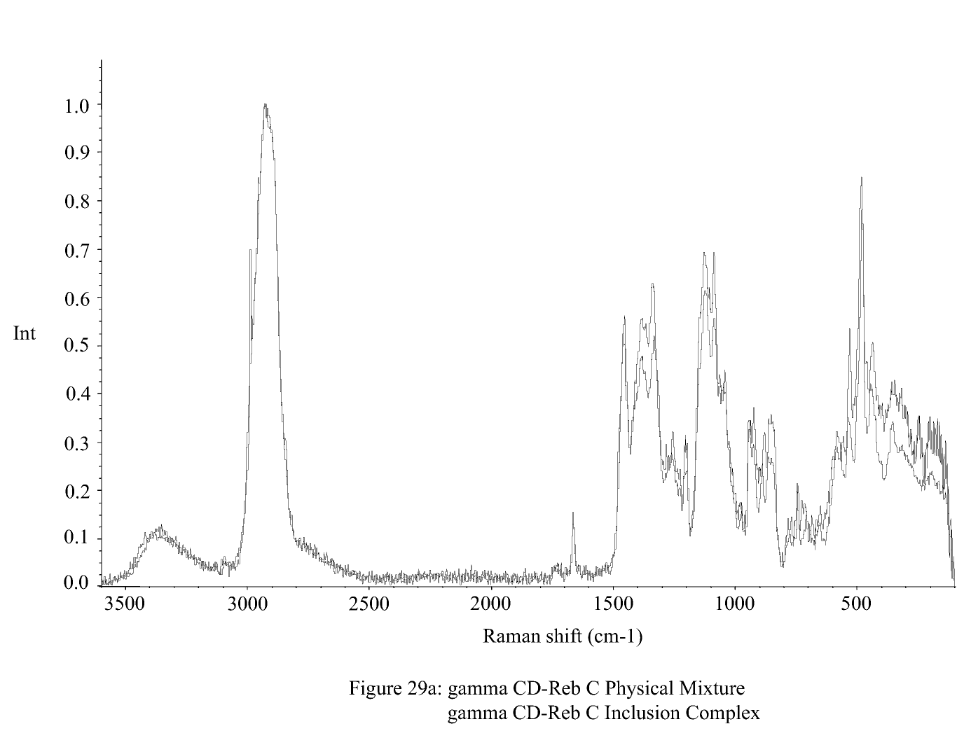

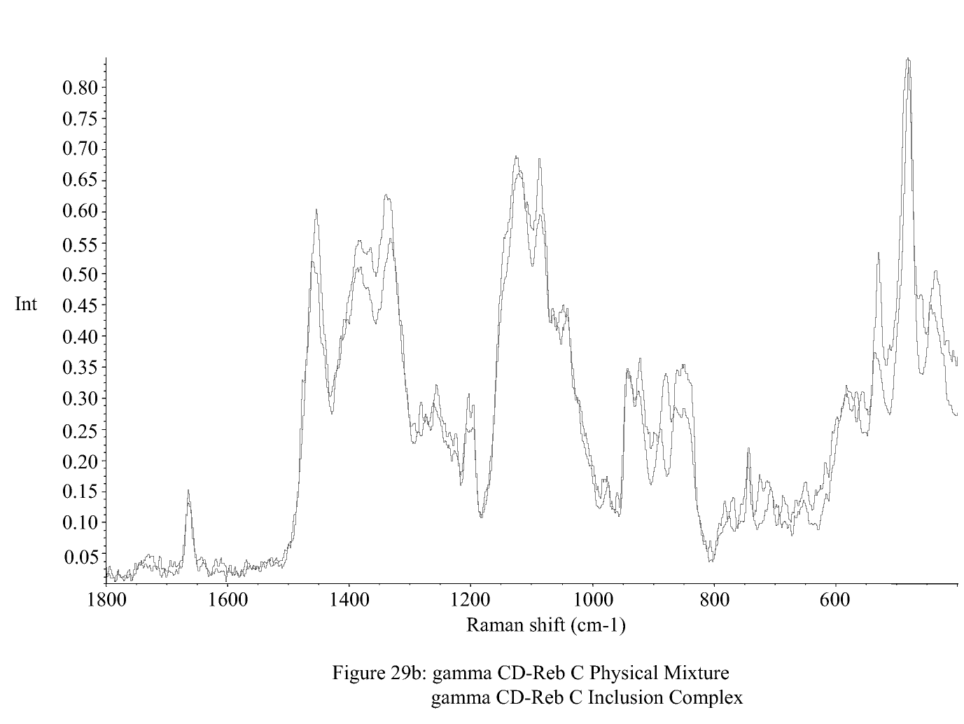

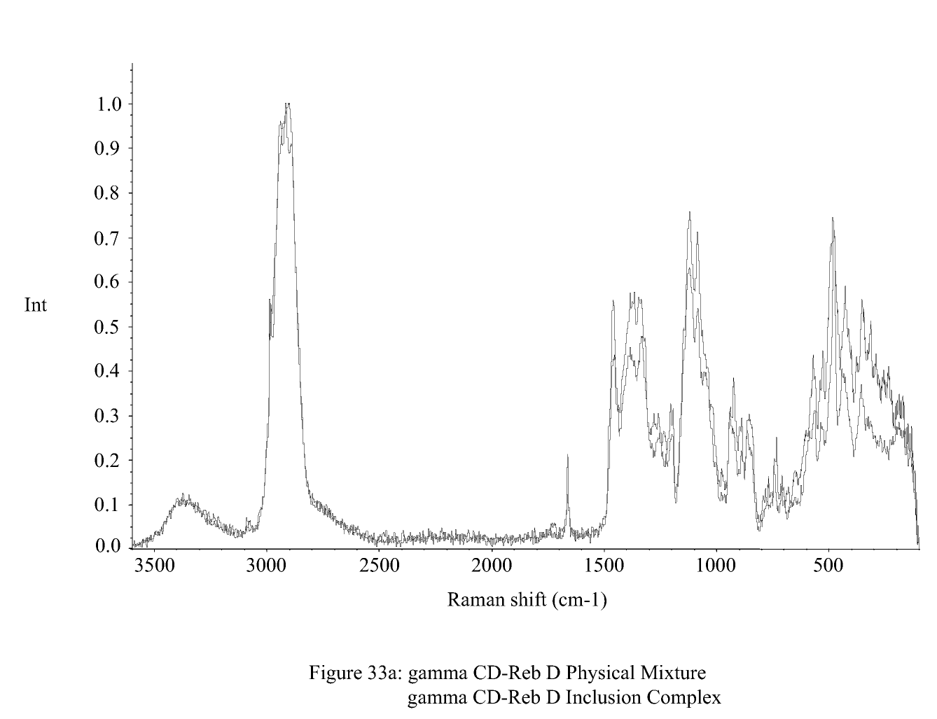

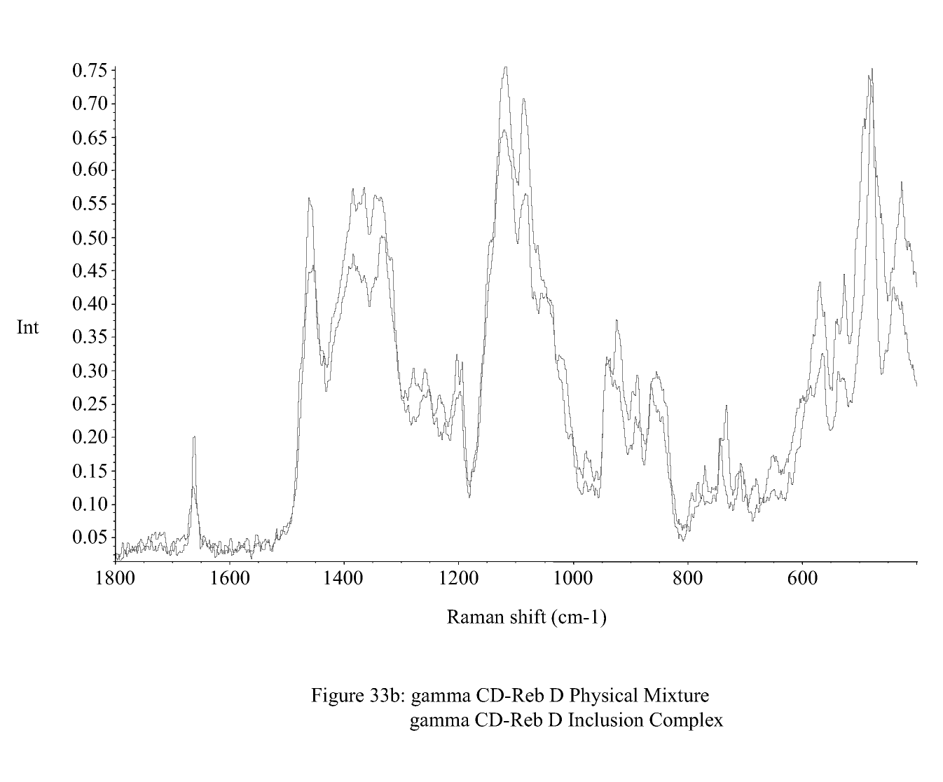

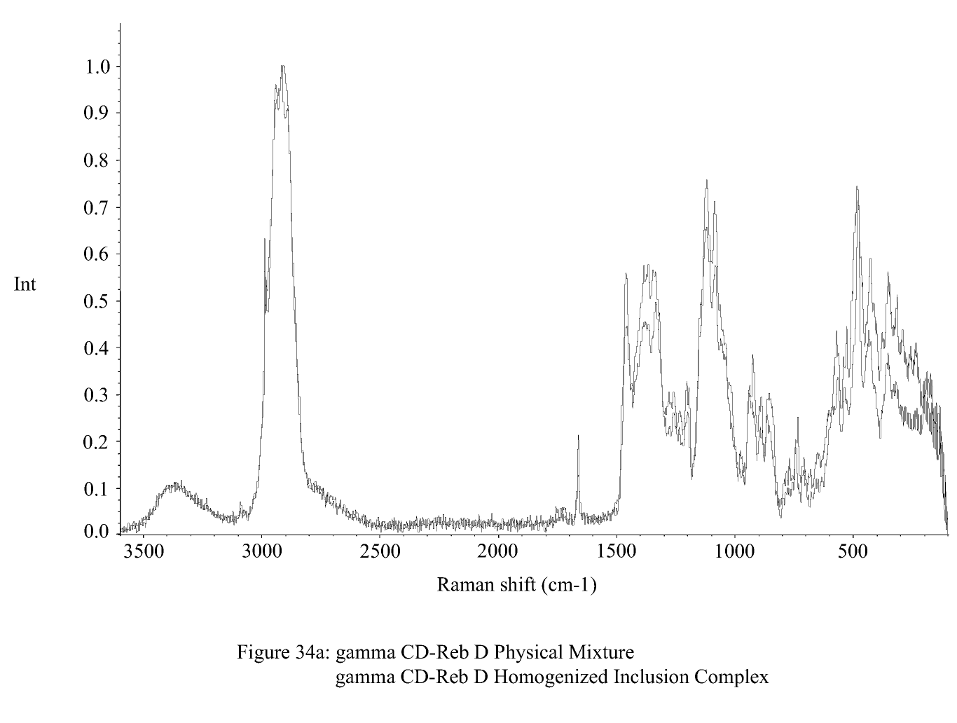

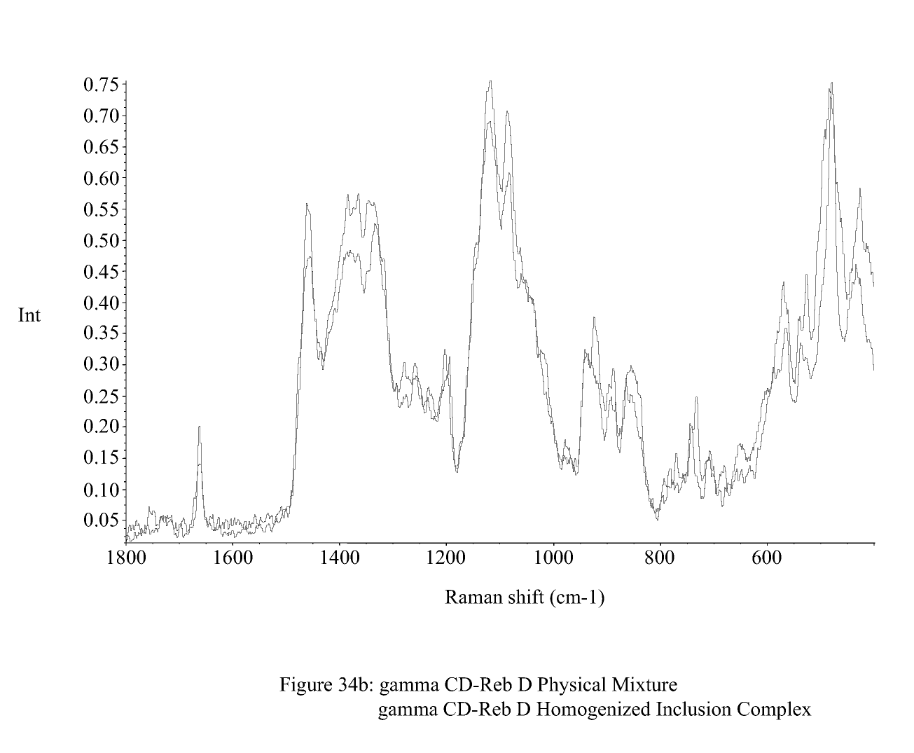

FIGS. 24a, 24b, 29a, 29b, 33a, 33b, 34a, and 34b display overlays of the intensity normalized Raman spectra of each inclusion complex with its corresponding physical mixture. Variations in band positions and intensities are observed between the Raman spectra of the inclusion complexes and corresponding physical mixtures, consistent with differences in solid state compositions of each sample set. For example, each physical mixture spectrum displays weak peaks near 1280 and 1230 cm⁻¹ that are absent in the spectra of the inclusion complexes, with the exception of the homogenized inclusion complex of gamma cyclodextrin and rebaudioside D (FIGS. 34a and 34b), which displays only very weak peaks at these frequencies. Also, the peak near 1660 cm⁻¹ assigned to C═C stretching of the steviol glycosides is shifted 4 cm⁻¹ to higher frequency in the spectrum of rebaudioside A inclusion complex (FIGS. 24a and 24b), and is broadened in the spectra of homogenized inclusion complex of gamma cyclodextrin and rebaudioside D (FIGS. 34a and 34b) and rebaudioside D inclusion complex (FIGS. 33a and 33b).

Further differences between the Raman spectra of the inclusion complexes and corresponding physical mixtures include: the relatively narrower shape of the cyclodextrin peak near 480 cm⁻¹ in the spectra of the inclusion complex samples; and the appearance of a single sharp peak at 743 cm⁻¹ in the spectrum of each inclusion complex sample, in contrast to the one or more peaks present in this region with variable width and frequency in the spectra of the physical mixtures.

### Example 7

### Solubility

The solubility of the inclusion complexes prepared in Example 2 were assessed in water. To measure the solubility, a substantially pure terpene glycoside complexed with a cyclodextrin was combined with water with less than 1 minute of magnetic stirring. To prepare sample 1, 234.19 mg of γ-CD—Reb A (hydrate form) complex prepared as described in Example 2(A) was combined with water to total 7 g of solution (equivalent to 100 mg Reb A). To prepare sample 2, 473 mg of γ-CD—Reb C complex prepared as described in Example 2(B) was combined with water to total 10 g of solution (equivalent to 200 mg Reb C). To prepare sample 3, the amount of inclusion complex used to prepare sample 2 was doubled. To prepare sample 4, 107.5 mg of γ-CD —Reb D complex prepared as described in Example 2(C) was combined with water to total 5 g of solution (equivalent to 50.0 mg Reb D).

The solutions were monitored visually (with intermittent stirring) for any precipitation for several days. The results are depicted in Table 1 below. After 4 to 30 days these high concentration solutions were clear.

TABLE 1
Inclusion Complex Solubility

| | Inclusion | Concentration | | Visual |
|---|---|---|---|---|
| Sample | Complex | in Water | Time | Observation |
| 1 | γ-CD and Reb A | 1.43% | 30 days | clear |
| | (hydrate form) | | | |
| 2 | γ-CD and Reb C | 2% | 30 days | clear |
| 3 | γ-CD and Reb C | 4% | 4 days | clear |
| 4 | γ-CD and Reb D | 1% | 30 days | clear |

What is claimed is:

1. An inclusion complex comprising a substantially pure terpene glycoside and at least one cyclodextrin, wherein the solubility of the inclusion complex is greater than the solubility of the substantially pure terpene glycoside alone.

2. The inclusion complex of claim 1, wherein the at least one substantially pure terpene glycoside is in a form chosen from an anhydrous polymorph, a solvate polymorph, an amorphous, and a combination thereof.

3. The inclusion complex of claim 2, wherein the substantially pure terpene glycoside is in a hydrate form.

4. The inclusion complex of claim 1, wherein the substantially pure terpene glycoside is chosen from rebaudioside A; rebaudioside B; rebaudioside C; rebaudioside D; rebaudioside E; rebaudioside F; stevioside; steviolbioside; dulcoside A; rubusoside; steviol; steviol 13 O-β-D-glycoside; suavioside A; suavioside B; suavioside G; suavioside H; suavioside I; suavioside J; isosteviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; β-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; 1-[13-hydroxykaur-16-en-18-oate]β-D-glucopyranuronic acid; 13-[(2-O-β-D-glucopyranosyl-β-D-glucopyranosyl)oxy]-17-hydroxy-kaur-15-en-18-oic acid β-D-glucopyranosyl ester; 13-[(2-O-α-L-rhamnopyranosyl-3-O-β-D-glucopyranosyl-β-D-glucopyranosyl)oxy]kaur-16-en-18-oic acid-(2-O-β-D-glucopyranosyl-3-D-glucopyranosyl)ester; 13-[(2-O-β-D-glucopyranosyl-β-D-glucopyranosyl)oxy]-17-oxo-kaur-15-en-18-oic acid β-D-glucopyranosyl ester; 13-[(2-O-β-D-glucopyranosyl-β-D-glucopyranosyl)oxy]-17-oxo-kaur-15-en-18-oic acid β-D-glucopyranosyl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2-O-β-D-glucopyranosyl-3-D-glucopyranosyl)oxy]kaur-16-en-18-oic acid-(6-O-β-D-xylopyranosyl-β-D-glucopyranosyl)ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-β-D-glucopyranosyl) ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl)ester; 13-[(2-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid β-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-β-D-glucopyranosyl)oxy]kaur-16-en-18-oic acid β-D-glucopyranosyl ester; mogroside E; mogroside I A; mogroside I E; mogroside II A; mogroside II A₁; mogroside II B; mogroside II E; mogroside III; mogroside III A₂; mogroside IV; mogroside IV A; mogroside V; mogroside VI; 11-oxomogroside; 11-oxomogroside I A; 11-oxomogroside I A₁; 20-hydroxy-11-oxomogroside I A₁; 11-oxomogroside II A₁; 7-oxomogroside II E; 11-oxomogroside II E; 11-deoxymogroside III; 11-oxomogroside IV A; 7-oxomogroside V; 11-oxo-mogroside V; mogrol; 11-oxo-mogrol; siamenoside; siamenoside-1; isomogroside; isomogroside V; and polymorphic and amorphous forms thereof.

5. The inclusion complex of claim 4, wherein the substantially pure terpene glycoside is chosen from rebaudioside A, rebaudioside C, and rebaudioside D.

6. The inclusion complex of claim 5, wherein the substantially pure terpene glycoside is rebaudioside A in a hydrate form.

7. The inclusion complex of claim 1, wherein the at least one cyclodextrin is γ-cyclodextrin.

8. The inclusion complex of claim 1, wherein the terpene glycoside to cyclodextrin ratio ranges from 1:1 to 1:20.

9. The inclusion complex of claim 1, wherein the solubility of the inclusion complex ranges from 0.1% to 7%.

10. The inclusion complex of claim 9, wherein the solubility of the inclusion complex ranges from 0.2% to 5%.

11. An inclusion complex comprising rebaudioside A and at least one cyclodextrin, wherein the rebaudioside A is in a hydrate form and the solubility of the inclusion complex is greater than the solubility of the rebaudioside A alone.

12. The inclusion complex of claim 11, wherein the at least one cyclodextrin is γ-cyclodextrin.

13. A beverage composition, comprising at least one inclusion complex comprising a substantially pure terpene glycoside and at least one cyclodextrin, wherein the solubility of the inclusion complex is greater than the solubility of the substantially pure terpene glycoside alone.

14. The beverage composition of claim 13, wherein the at least one inclusion complex is present in the composition in an amount ranging from 0.1% to 7%, by weight relative to the total weight of the composition.

15. The beverage composition of claim 14, wherein the at least one inclusion complex is present in the composition in an amount ranging from 0.2% to 5%, by weight relative to the total weight of the composition.

16. The beverage composition of claim 13, wherein the substantially pure terpene glycoside is in a form chosen from an anhydrous polymorph, a solvate polymorph, an amorphous, and a combination thereof.

17. A method for increasing the solubility of a substantially pure terpene glycoside, comprising combining a substantially pure terpene glycoside with at least one cyclodextrin to form at least one inclusion complex.

18. The method of claim 17, further comprising combining at least one inclusion complex with an orally ingestible composition.

19. The method of claim 17, wherein the step of combining the substantially pure terpene glycoside with at least one cyclodextrin to form at least one inclusion complex comprises
adding the substantially pure terpene glycoside and at least one cyclodextrin to an aqueous solution,
heating the aqueous solution,
adding at least one alcohol to the aqueous solution, and
freeze drying the aqueous solution.

20. The method of claim 18, wherein the at least one inclusion complex is present in a total amount ranging from 0.1% to 5%, by weight relative to the total weight of the orally ingestible composition.

21. The method of claim 17, wherein the substantially pure terpene glycoside is in a form chosen from an anhydrous polymorph, a solvate polymorph, an amorphous, and a combination thereof.

22. A method for improving the taste of an orally ingestible composition, comprising adding at least one inclusion complex comprising a substantially pure terpene glycoside and at least one cyclodextrin to an orally ingestible composition, wherein the at least one inclusion complex is present in the composition in an amount ranging from 0.1% to 5%, by weight relative to the total weight of the orally ingestible composition.

23. The method of claim 22, wherein the substantially pure terpene glycoside is in a form chosen from an anhydrous polymorph, a solvate polymorph, an amorphous, and a combination thereof.

24. An inclusion complex comprising at least two substantially pure terpene glycosides and at least one cyclodextrin, wherein the solubility of the inclusion complex is greater than the solubility of the substantially pure terpene glycosides alone.

25. A beverage composition, comprising at least one inclusion complex comprising at least two substantially pure terpene glycosides and at least one cyclodextrin, wherein the solubility of the inclusion complex is greater than the solubility of the substantially pure terpene glycosides alone.
